(19) United States
(12) Patent Application Publication
(10) Pub. No.: US 2024/0247999 A1
(43) Pub. Date: Jul. 25, 2024

(54) Long-Duration Shock Testing Machine

(71) Applicant: Omnitek Partners LLC, Ronkonkoma, NY (US)

(72) Inventor: Jahangir S. Rastegar, Stony Brook, NY (US)

(73) Assignee: Omnitek Partners LLC, Ronkonkoma, NY (US)

(21) Appl. No.: 18/444,702

(22) Filed: Feb. 18, 2024

Related U.S. Application Data
(63) Continuation-in-part of application No. 18/244,271, filed on Sep. 10, 2023.
Application No. 18/244,271 is a continuation-in-part of application No. 17/555,609, filed on Dec. 20, 2021.
(60) Provisional application No. 63/128,111, filed on Dec. 20, 2020.

(51) Int. Cl. G01M 7/08; F41A 31/00

(52) U.S. Cl. CPC G01M 7/08; F41A 31/00

(57) ABSTRACT

A shock testing machine including a platform for holding an item to be shock tested; a brake engaging member separately provided from the platform and movable relative to the platform. The brake engaging member contacts the platform when the platform is moving other than in a braking phase. One or more rails movably supporting the platform and the brake engaging member. A stop configured to stop the brake engaging member from moving in a testing direction at a location while allowing the platform to continue moving past the predetermined location. A brake configured to decelerate the platform after the brake engaging member is stopped by the stop. The brake being movable relative to the platform and the brake engaging member. The brake engaging member is between the platform and the brake and the brake contacting the brake engagement member when the platform is moving in the braking phase.

### CROSS-REFERENCE TO RELATED APPLICATION

This application is a continuation in part of U.S. patent application Ser. No. 18/244,271, filed on Sep. 9, 2023, which is a continuation in part of U.S. patent application Ser. No. 17/555,609, filed on Dec. 20, 2021, which claims priority to U.S. Provisional Application No. 63/128,111 filed on Dec. 20, 2020, the entire contents of which is incorporated herein by reference.

### BACKGROUND

### 1. Field

The present disclosure is generally directed to long-duration high-G shock testing machines, and more particularly to low-cost fast set-up and reusable testing machines and methods capable of imposing high accelerations and decelerations that are sustained over relatively long durations of over 2-3 msec. Such machine would provide the means for testing ordnance and commercial products/components under high-G shock loading.

### 2. Prior Art

Gun-fired munitions, mortars and rail-gun munitions are subjected to high-G (setback and set-forward) acceleration during launch and target impact. Rockets are generally subjected to lower G accelerations but for significantly longer durations. High-G accelerations are also experienced during impact in munitions and in many other devices during their planned operation. Similar but more complex combinations of axial as well as lateral and bending shock loadings are experienced by air dropped weapons as they impact the target, particularly when the weapon is rocket assisted to achieve high impact velocities and when the target structure is highly heterogeneous, such as reinforced concrete or soil with large rock content. As a result, all components of the system and the system itself must survive such shock loading events and be qualified to such severe environments. High-G loading is also experienced by almost all objects during accidental drop or other similar accidental events.

Component qualification testing cannot obviously be done in an actual environment on complete assemblies. In addition to prohibitive cost involved, testing of components in actual environments would not provide the required information for determining the required component and system design margins. For these reasons, laboratory simulations of the shock loading environments are highly desirable for testing individual components, subassemblies and sometimes the complete system assembly.

In the current state of the art, shock loading environments are simulated in the industry by one of the following methods:

### 1. Electro-Dynamic Shaker.

This method can accurately produce a desired shock response spectrum (SRS) within closely specified tolerances, but amplitude and frequency limitations of the equipment greatly restrict its applicability.

2. Live Ordnance with System Structure.

Since the actual system structure and live ordnance are used, this method has the potential to produce a shock virtually identical to the expected field environment. The cost of the test structure, however, is usually prohibitive, unless large numbers of identical tests are to be conducted. The use of live ordnance may have a wide repeatability tolerance, and does not easily allow the test levels to be increased so that an adequate design margin can be assured. For the case of gun-fired munitions, mortars and the like, the added problem is the “soft” recovery of the launched round to examine the state of the components being tested. In certain case, telemetry of data may be used to transmit back data related to the operation of certain components. However, in most cases it is highly desirable to examine the state of the components post firing. In addition, in many cases it is extremely difficult if not impossible to measure/determine the effect of shock loading on many components for transmission to a ground station via telemetry.

3. Live Ordnance with Mock Structure.

This method has most of the same features as the method “2” above, except that some cost savings are attributed to the use of a mass mock-up structure. These savings may be negated by the need for some trial-and-error testing to attain the desired component input, where geometric similarity was used in method “2” above to attain the same result. This method also suffers from the same shortcomings for testing components of gun-fired munitions and mortars and the like as indicated for the above method “2”.

4. Live Ordnance with Resonant Fixture.

This method further reduces test cost, and is a candidate for general purpose testing, due to the use of a generic resonant plate fixture. Since live ordnance is used, all the very high frequencies associated with near-field pyrotechnic shock events are produced with this method. However, a great amount of trial-and-error testing may be required to obtain the desired component input.

5. Mechanical Impact with Mock Structure.

Mechanical impacts do not produce the very high frequencies associated with the stress pulse in the immediate vicinity of a pyrotechnic device. However, most components in a typical system are isolated by enough intermediary structure such that the shock at the component location is not dominated by these very high frequencies. Instead, the shock at the component is dominated by the structural response to the pyrotechnic device, and has dominant frequencies which are typically less than 10 KHz. For these components, a mechanical impact (e.g. using a projectile or pendulum hammer) can produce a good simulation of the pyrotechnic shock environment. Test amplitudes can easily be increased or decreased by simply increasing or decreasing the impact speed. The shock level and duration can be controlled to some extent by the use of various pads affixed at the point of impact. According to this method, attempt is made to subject the structure containing the test components the impact induced acceleration (shock) profile, which close to that experienced when assembled in the actual system. The test conditions are experimentally adjusted to achieve an approximation of the actual acceleration (shock) profile. In general, a large amount of trial-and-error runs have to be made to achieve an acceptable acceleration (shock) profile. The characteristics and response of the various pads used at the impact point to increase the duration of the shock (acceleration) event is generally highly variable and dependent on temperature and moisture. In addition, due to inherent design of such mechanical impact machines and the limitations on the thickness of the pads that can be used at the impact point, high G acceleration peaks with long enough duration similar to those, e.g., experienced by munitions fired large caliber guns or mortars, cannot be achieved. For example, to achieve a peak shock acceleration level of 5000 G with a duration of 4 milliseconds, the said pad deformation has to be well over 0.6 meters (considering a reasonable ramp-up and ramp-down of 0.1 meters each), which is highly impractical. It is also appreciated by those skilled in the art that for simulating firing (setback) acceleration for most gun-fired munitions and mortars, the peak acceleration levels can generally be well over the considered 5000 Gs with significantly longer durations. It can therefore be concluded that the described mechanical impact machines do not accurately duplicate the shock profile experienced by munitions during firing or target impact and are not suitable for accurate shock testing of components to be used in such munitions.

6. Mechanical Impact with Resonant Fixture.

In this method, a resonant fixture (typically a flat plate) is used instead of a mock structure. This significantly reduces cost, and allows for general purpose testing since the fixturing is not associated with a particular structural system. The mechanical impact excites the fixture into resonance which provides the desired input to a test component mounted on the fixture. Historically, test parameters such as plate geometry, component location, impact location and impact speed have been determined in a trial-and-error fashion. In general, this method produces a simulated environment which has its energy concentrated in a relatively narrow frequency bandwidth. It should be noted here that a suitable resonant fixture for use in this method may also be a bar impacted either at the end or at some point along the length of the bar. This method is suitable for many applications in which the components are subjected to relatively long term vibration such as those induced by the system structure. The method is, however, not suitable for testing components of gun-fired munitions and the like since in such cases the munitions is subjected primarily to a single very high G setback or impact shock with relatively long duration.

### 7. Air-Gun Testing Platforms.

In this method, the components to be tested are usually mounted in a “piston” like housing with appropriate geometry. In one method, the said “piston” is then accelerated by the sudden release of pressurized air or accelerated by the rupture of a diaphragm behind which air pressure is continuously increased until the diaphragm is failed in sheared. In another type of air gun a similar air tight “piston” within which the components to be tested are securely mounted is accelerated over a certain length of a tube by pressurized gasses. The “piston” is thereby accelerated at relatively slower rates and once it has gained a prescribed velocity, the “piston” existing the tube and impacts decelerating pads of proper characteristics such as aluminum honeycomb structures to achieve the desired deceleration amplitude and duration. The components are assembled inside the “piston” such that the said deceleration profile to correspond to the desired actual shock (acceleration) profile. In general, similar to the above method 5, air guns can be used to subject the test components to high G shock (acceleration) levels of over 30,000 Gs but for durations that are significantly lower than those experienced by gun-fired munitions, mortars and the like. It can therefore be concluded that the described mechanical impact machines do not accurately duplicate the shock profile experienced by munitions during firing or target impact and are not suitable for accurate shock testing of components to be used in such munitions.

### 8. Rocket Sleds.

Rocket sled is a test platform that slides along a set of rails, propelled by rockets. As its name implies, a rocket sled does not use wheels. Instead, it has sliding pads, called “slippers”, which are curved around the head of the rails to prevent the sled from flying off the track. The rail cross-section profile is usually that of a Vignoles rail, commonly used for railroads. Rocket sleds are used extensively aerospace applications to accelerate equipment considered too experimental (hazardous) for testing directly in piloted aircraft. The equipment to be tested under high acceleration or high airspeed conditions are installed along with appropriate instrumentation, data recording and telemetry equipment on the sled. The sled is then accelerated according to the experiment's design requirements for data collection along a length of isolated, precisely level and straight test track. This system is not suitable for testing components for gun-fired munitions and mortars and the like since it can produce only around 100-200 Gs.

### 9. Soft Recovery System Facility (SCat Gun)

In this system, the components to be tested are packaged inside a round, which is fired by an actual gun (in the current system located at the U.S. Army Armament Research, Development and Engineering Center (ARDEC) in New Jersey, with a 155 mm round being fired by a 155 mm Howitzer weapon with a M199 gun tube and 540 feet of catch tubes). The projectile is then recovered using a “Soft Recovery” system. The soft catch component of the system uses both pressurized air and water to help slow down the projectile. The first part of the chain of catch tubes only contains atmospheric air. The next section, 320 feet of the tubes, contains pressurized air, followed by an 80 feet section that is filled with water. A small burst diaphragm seals one end of the pressurized air and a piston seals the other end. The piston also separates the water and pressurized air sections. The burst diaphragm and piston are replaced after each test fire. Once fired, the projectile achieves free flight for approximately 6 feet and travels down the catch tubes, generating shockwaves that interact with the atmospheric air section, the burst diaphragm, the pressurized air section, the piston and the water section. The air section is compressed and pushed forward and shock and pressure cause the piston move against the water, all while slowing the projectile to a stop. Then the piston is ejected out of the end of the system, followed by the air and water, and finally the projectile comes to rest in a mechanized brake system. On-board-recorders inside the projectile measure the accelerations of the projectile from the gun-launch and the catch events. This system is currently provides the means to subject the test components to as realistic firing shock loading conditions as possible and provide the means to retrieve the round to examine the tested components. The cost of each testing is, however, very high, thereby making it impractical for use for engineering development. The system is also impractical for use for most reliability testing in which hundreds and sometimes thousands of samples have to be tested and individually instrumented. It also takes hours to perform each test.

The methods 1-6 described above are more fully explained in the following references: Daniel R. Raichel, “Current Methods of Simulating Pyrotechnic Shock”, Pasadena, Calif.: Jet Propulsion Laboratory, California Institute of Technology, Jul. 29, 1991; Monty Bai, and Wesley Thatcher, “High G Pyrotechnic Shock Simulation Using Metal-to-Metal Impact”, The Shock and Vibration Bulletin, Bulletin 49, Part 1, Washington D.C.: The Shock and Vibration Information Center, September, 1979; Neil T. Davie, “The Controlled Response of Resonating Fixtures Used to Simulate Pyroshock Environments”, The Shock and Vibration Bulletin, Bulletin 56, Part 3, Washington D.C.: The Shock and Vibration Information Center, Naval Research Laboratory, August 1986; Neil T. Davie, “Pyrotechnic Shock Simulation Using the Controlled Response of a Resonating Bar Fixture”, Proceedings of the Institute of Environmental Sciences 31st Annual Technical Meeting, 1985; “The Shock and Vibration Handbook”, Second Edition, page 1-14, Edited by C. M. Harris and C. E. Crede, New York: McGraw-Hill Book Co., 1976; Henry N. Luhrs, “Pyroshock Testing—Past and Future”, Proceedings of the Institute of Environmental Sciences 27th Annual Technical Meeting, 1981.

The aforementioned currently available methods and systems for testing components to be used in systems that subject them to acceleration (shock) events have a number of shortcomings for use to simulate high G acceleration (shock) events with relatively long duration, such as those encountered in large caliber guns and mortars, for example, to simulate gun-firing events with setback accelerations of over 3000 G-5,000 Gs and durations of around 5-10 milliseconds. Firstly, most of the available methods and devices, except those that are based on actual firing of the projectile from the actual gun or mortar or the like, cannot provide long enough acceleration pulse duration. Secondly, those methods that are based on actual firing of the projectile from the actual gun or mortar or the like have prohibitive cost, thereby making them impractical for engineering development tasks which requires countless iterations to achieve the desired results for individual components as well as for their assemblies. In addition, reliability tests for munitions components required testing of a very large number of components, which would make the total cost of munitions development prohibitive. Thirdly, in many component tests, it is highly desirable to instrument each component so that its behavior during the total shock environment can be monitored. Such instrumentation and monitoring is very difficult to achieve when the components to be tested have to be assembled in a rather small volume of fired projectiles.

Developing a controllable test method and predictive capability to apply this environment in testing is critical to the development of fuze, energetic, and other weapon technologies and for the development of products that can survive accidental drops or impact due to transportation vibration and the like. In munitions and other similar systems, to subject the device or system to the required acceleration events typically requires ballistic or operational testing. Both testing methods are extremely costly, personnel intensive, and introduce both technical and safety risks.

The vast majority of aircraft and satellite components, whether military or commercial, must be tested under certain shock loading conditions. That is, aircraft components must be shock tested to ensure that their design will survive its intended environment. Consequently, different aircraft components may have widely varying shock testing requirements. Currently, there is no one shock testing apparatus that can shock test aircraft components to accommodate the varying shock testing requirements for aircraft components, if at all. Thus, the industry resorts to building specialized shock testing machines or using computer simulation for shock testing, methods which are expensive and/or inaccurate.

In addition to rigorous vibration profiles, many consumer electronic components must be shock tested to determine how they will perform under certain shock conditions. Electronic components are often shock tested to determine how they will survive under unintended conditions, such as repetitive dropping. Of such consumer electronic components, device casings and circuit boards are often shock tested to determine survivability due abuse while other electronic devices are designed for heavy duty usage, such as in the construction trade and must be shock tested to determine if they are fit for their particular harsh environment. The current shock testing methods for consumer electronic devices have the same shortcomings as those described above regarding commercial aircraft. Current shock testing machines in the consumer electronics area are either very simple drop testing from heights or pneumatic shock machines, both of which are inaccurate, and their repeatability is unreliable.

Automobile components (as well as light and heavy-duty truck components) must also undergo rigorous shock testing under normal use as well as components which can fail during a crash. Some automobile components must undergo shock testing to determine how they will perform under normal conditions, such as some structural frame components while other components must undergo shock testing to determine their performance during a crash, such as electronic components, steering wheels, airbags and the like. Like other shock testing machinery currently available in the areas of commercial aircraft and consumer electronics, the shock testing of automobile components is inaccurate, their repeatability is unreliable, and they can also be relatively expensive.

In addition, currently available high-G shock loading machines, even those applying relatively low accelerations levels in the range of, for example 10 G-500 G, are not capable of applying the acceleration over relatively long durations, for example 500 G over 10 milliseconds.

The basic design of a mechanical shock testing machine 10 of prior art that uses the aforementioned method “6” is shown in the schematic of FIG. 1. The schematic of FIG. 1 is intended to show only the main components of such a mechanical shock testing machine. The mechanical shock machine 10 is constructed with some type of rails 12 along which the impact mass element 11 travels. The rails (one or more) may have any cross-sectional shape and the sliding surfaces between the mass element 11 and the rails 12 may be covered with low friction material or may utilize rolling elements to minimize sliding friction. The rails 12 are generally mounted on a relatively solid and massive base 13, which in turns rests on a firm foundation 14. Certain relatively stiff shock absorbing elements (not shown) may be provided between the base 13 and the ground 14 to prevent damage to the foundation structure. In heavier machinery, a relatively large (usually made out of reinforced concrete) foundation block (not shown) is used with shock isolation elements having been positioned between the foundation block and the surrounding structure.

The components to be tested 15 are attached fixedly to the mass element 11, usually via a fixture 16. In the mechanical shock machine 10, the mass element 11 acts as a “hammer” that is designed to impact an anvil 17, FIG. 1, to impart the desired shock loading (deceleration profile in the present mechanical shock testing machine) onto the components 15 that are to be tested. The anvil 17 is generally desired to be very rigid as well as massive and be securely attached to the base 13 of the mechanical shock testing machine, FIG. 1. In many cases, the mass element 11 is provided with an impact element 18, which is designed to have a relatively sharp and hard tip 19.

To perform shock testing of the components 15, the mass element 11 (“hammer” element) is accelerated downwards in the direction of the arrow 20 towards the anvil 17. The present shock testing machines are usually installed vertically. In which case and when relatively low impact shock (deceleration) levels or very short shock durations are desired, the mass element 11 is accelerated in the direction of the arrow 20 under the gravitational acceleration, with the height of travel determining the level of velocity attained by the mass element (“hammer”) at the time of impacting the anvil 17. In other mechanical shock testing machines, particularly when higher mass element 11 velocity at impact velocity is desired, other means such as pre-tensioned bungee cords or pneumatic cylinders (not shown) are also used to significantly increase downward acceleration of the mass element 11 (in the direction of the arrow 2), thereby significantly increasing the impact speed between the mass element 11 (the “hammer” element) and the anvil 17. In those cases in which the mechanical shock testing machine 10 is installed horizontally (not shown), the mass element 11 is accelerated in the direction of the arrow 20 by the aforementioned pre-tensioned bungee cords or pneumatic cylinders or even linear motors.

The shock (deceleration) level experienced by the mass element 11 and thereby the test components 15 and its duration can be controlled to some extent by the use of various pads 21 affixed at the point of impact, i.e., between the anvil 17 surface and the impacting tip 19 of the impact element 18 of the mass element 11 (“hammer”). The shock (deceleration pulse) amplitude is also increased or decreased by simply increasing or decreasing the impact speed. The test conditions are experimentally adjusted to achieve as close approximation of the actual acceleration (shock) profile as possible.

### SUMMARY

It is therefore an object to develop a low-cost, reusable testing method and accompanying experimental and simulation capabilities that can reproduce acceleration/time profiles representative of munitions firing, weapon target penetration as well as shock loading experienced by various weapon systems and commercial products. This includes the experienced acceleration amplitude for a duration.

It is also appreciated that it is critical that the shock testing system be scalable so that they would enable testing of both small and larger devices and systems. In this regard, the shock testing system can test articles ranging from circuit boards for consumer electronics weighing several ounces to ordnances/components weighing several pounds.

A need therefore exists for the development of novel methods and resulting testing apparatus (shock testing machines) for testing components of gun-fired munitions, mortars and other devices and systems that are subjected high G acceleration (shock loading) with a relatively long duration such as projectiles fired by large caliber guns, mortars and the like. The developed methods should not be based on the use of the actual or similar platforms, for example, firing projectiles carrying the test components with similar guns such as the described in the method “9” above, due to the cost and difficulty in providing full instrumentation which would allow testing of a few components at a time, thereby making the cost of engineering development of such components and their reliability testing which requires testing of a large number of samples prohibitively high.

A need therefore exists for the development of novel methods and resulting testing apparatus (shock testing machines) for testing components of munitions such as rockets and other devices and systems that are subjected relatively low G acceleration (shock loading in tens of G rather than hundreds and thousands in the case of gun-fired munitions and mortars and those experienced during impact and the like) with relatively long duration. The developed methods should not be based on the use of the actual or similar platforms, for example, firing rockets carrying the test components, due to the cost and difficulty in providing full instrumentation which would allow testing of a few components at a time, thereby making the cost of engineering development of such components and their reliability testing which requires testing of a large number of samples prohibitively high.

A need also exists for novel mechanical shock testing machines that can provide the means of testing a large number of fully instrumented components in a relatively short time. This requires that the said mechanical shock testing machine allows rapid mounting of test components onto the test platform while allowing relatively free access to the said components, unlike the “piston” platforms used in air guns (aforementioned method “7”) or inside projectiles that are gun-launched (aforementioned method “9”).

The novel mechanical sock testing must also provide highly predictable and repeatable shock loading (acceleration) provide for testing the intended components so that the results can be used for detailed analytical model validation and tuning; for predicting the performance of the components in actual applications; and for providing the required information for the configuration of the said components and optimization of the developed configurations.

Herein is described a novel method for the configuration of shock testing machines and the resulting shock testing machines that can subject test components and systems to long duration high G acceleration pulse (shock) events. The resulting shock testing machines are shown to address the aforementioned needs and are particularly suitable for engineering development and testing of components to be used in gun-fired munitions, mortars and the like. The method is also shown to be capable of providing a configuration of shock loading machines for a wide range of acceleration and its duration.

Accordingly, shock testing machines are provided that can impart relatively long duration acceleration with a wide range of magnitudes on objects being tested. The shock testing machine provide the means of rapidly mounting and dismounting objects to be tested on the machine platform and resetting the machine for the next test. The acceleration (shock loading) level to be achieved is readily adjusted and measured via adjusting and measuring the braking force that will be provided during the testing.

It is also appreciated that in certain applications, it is highly desirable to apply acceleration shock to an object from rest to a certain velocity or for a certain duration of time, particularly for relatively long durations. For example, it is highly desirable to test components used in rockets, missiles, and gun-fired munitions at acceleration of the order of 300-500 G from rest for 4-10 milliseconds.

A need therefore exists for novel mechanical acceleration shock testing machines that can provide the means of testing various objects as being subjected to high accelerations for relatively long durations as experienced in rockets, missiles, and gun-fired munitions from rest.

Herein is described a novel method for the development of mechanical acceleration shock testing machines using pneumatically powered actuation and the resulting acceleration shock testing machines that can subject test components and systems to long duration high G acceleration pulse (shock) events. The resulting acceleration shock testing machines are shown to address the aforementioned needs and are particularly suitable for engineering development and testing of components to be used in gun-fired munitions, mortars, rocket, missiles, and in testing various commercial components that may be subjected to such acceleration shock events. The method is also shown to be capable of providing acceleration shock loading machines for a wide range of acceleration levels and their duration.

Accordingly, novel acceleration shock testing machines that use pneumatically powered actuation systems are provided that can impart relatively long duration acceleration with a wide range of magnitudes on objects being tested. The acceleration shock testing machines provide the means of rapidly mounting and dismounting objects to be tested on the machine test platform and resetting the machine for the next test. The acceleration shock loading level and duration to be achieved are readily adjusted and measured.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates the basic design of a mechanical shock testing machine of prior art.

FIG. 2A illustrates the isometric view of the first embodiment of the mechanical shock testing machine.

FIG. 2B illustrates a close up view of the test carriage and platform of the mechanical shock testing embodiment of FIG. 2A.

FIG. 3 illustrates the isometric view of the cross-sectional view A-A of the carriage assembly of the mechanical shock testing machine of FIG. 2B.

FIG. 4 illustrates the isometric view of the mechanical shock testing machine embodiment of FIG. 2B with a cut-away view of the braking mechanism section of the machine.

FIG. 5 illustrates the cross-sectional view B-B of the isometric view of FIG. 4.

FIG. 6 illustrates the isometric view of the second embodiment of the mechanical shock testing machine.

FIG. 7 illustrates the first method of accelerating the carriage member of the mechanical shock testing machine to the desired velocity.

FIG. 8 illustrates a modified version of the vertical shock loading machine embodiment of FIG. 7.

FIG. 9 illustrates the cross-sectional view C-C of the braking mechanism of the shock loading machine embodiment of FIG. 8.

FIG. 10 illustrates the second method of accelerating the carriage member of the mechanical shock testing machine to the desired velocity.

FIG. 11 illustrates the third method of accelerating the carriage member of the mechanical shock testing machine to the desired velocity.

FIG. 12 illustrates the isometric view of the modified embodiment of the mechanical shock loading machine of FIG. 6.

FIG. 13 illustrates the cross-sectional view E-E of the mechanical shock loading machine embodiment of FIG. 12 showing the cross-sectional view of the test platform and the braking member of the machine.

FIG. 14 illustrates the cross-sectional view D-D of the mechanical shock loading machine embodiment of FIG. 12 showing the cross-sectional view of the braking member of the machine.

FIG. 15 illustrates the cross-sectional view F-F of the braking member of the mechanical shock loading machine embodiment of FIG. 12.

FIG. 16 illustrates the top view “G” of FIG. 12 of the modified braking member and the braking strip with the braking strip vertically positioned as compared to the horizontally positioned in FIG. 14. The braking member is shown as it approaches the stop member during shock loading tests.

FIG. 17A illustrates the isometric view of another embodiment of the mechanical shock testing machine of the present invention.

FIG. 17B illustrates the isometric view of the mechanical shock testing machine embodiment of FIG. 17A as the machine test platform begins to be decelerated by the applied friction force.

FIG. 17C illustrates the isometric view of the mechanical shock testing machine embodiment of FIG. 17A as the machine test platform is being decelerated to a stop.

FIG. 18A illustrates the novel method of accelerating the test platform of mechanical shock testing machine embodiment of FIG. 17 by pre-stretched bungees.

FIG. 18B illustrates the method of detaching the pre-stretched bungees from the test platform as the test platform deceleration phase is to begin. The bungee is still stretched with a prescribed significant tension.

FIG. 19 illustrates the top view “G” of the braking member of the mechanical shock testing machine embodiment of FIG. 17A.

FIG. 20 illustrates the top view “H” of the “brake engaging member” and stop members of the mechanical shock testing machine embodiment of FIG. 17A.

FIG. 21A illustrates the isometric view of another embodiment of the mechanical shock testing machine of the present invention.

FIG. 21B illustrates the isometric view of the mechanical shock testing machine embodiment of FIG. 21A during its deceleration phase to a stop.

FIG. 22 illustrates the side view “K” of the “braking member assembly” of the mechanical shock testing machine embodiment of FIG. 21A.

FIG. 23 illustrates the cross-sectional view J-J of the “braking member assembly” of the mechanical shock testing machine embodiment of FIG. 21A.

FIG. 24 illustrates the cross-sectional view J-J of the “braking member assembly” of the mechanical shock testing machine embodiment of FIG. 21A with an alternative active means of releasing the braking mechanism as compared to the passive means of FIG. 23 view.

FIG. 25 illustrates the isometric view of the friction force measuring and adjustment attachment design as employed to the mechanical shock testing machine embodiment of FIG. 17A.

FIG. 26 illustrates the cross-sectional view M-M of the friction force measuring attachment as employed to the mechanical shock testing machine embodiment of FIG. 17A.

FIGS. 27A and 27B illustrate the method of friction force measuring and adjustment for the mechanical shock testing machine of the type of the embodiments of FIG. 12.

FIG. 28 illustrates the winch mechanism used to stretch the bungees of the mechanical shock testing machine embodiment of FIG. 12 while measuring the tensile force provided by the bungees.

FIG. 29 illustrates the schematic of the pneumatic acceleration shock testing machine embodiment of the present invention.

FIG. 29A illustrates the schematic of the pneumatic acceleration shock testing machine embodiment of FIG. 29 as configured for testing a lanyard operated device by subjecting it to a prescribed lanyard pull acceleration and velocity profile.

FIG. 30 illustrates the schematic of the modified pneumatic acceleration shock testing machine embodiment of FIG. 29.

### DETAILED DESCRIPTION OF THE PREFERRED EMBODIMENT

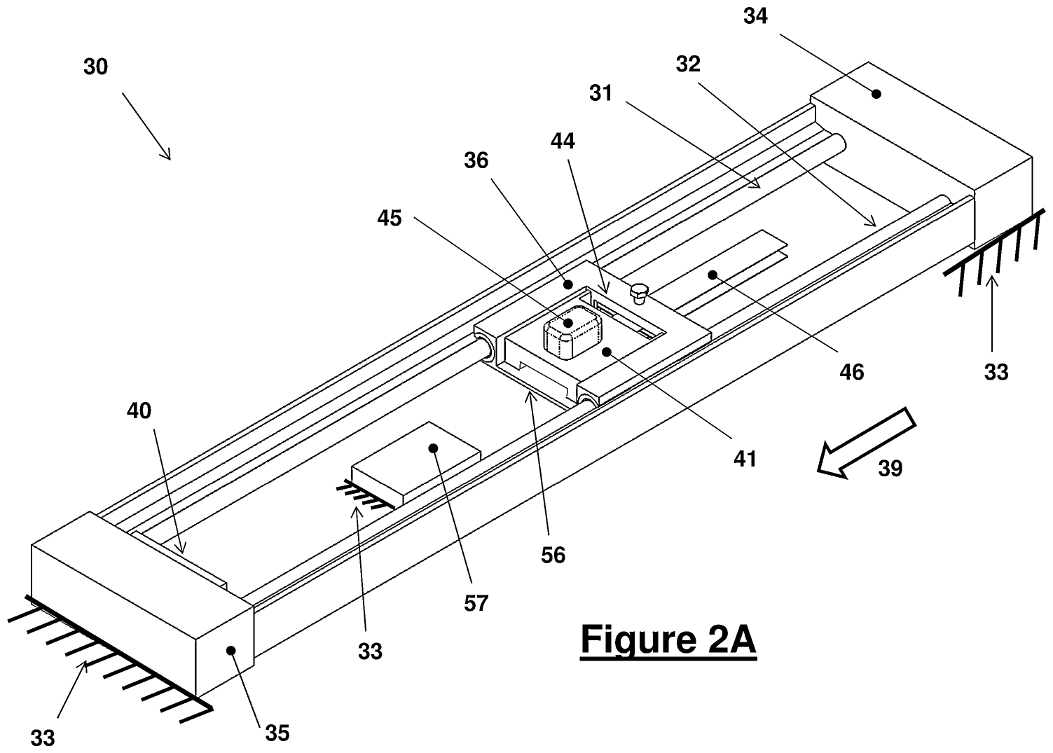

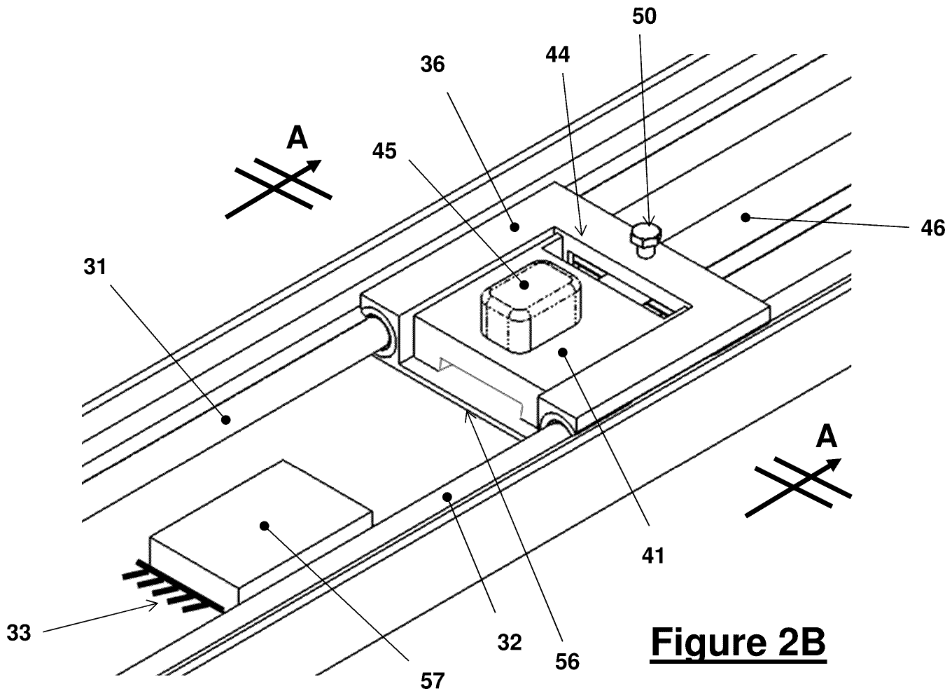

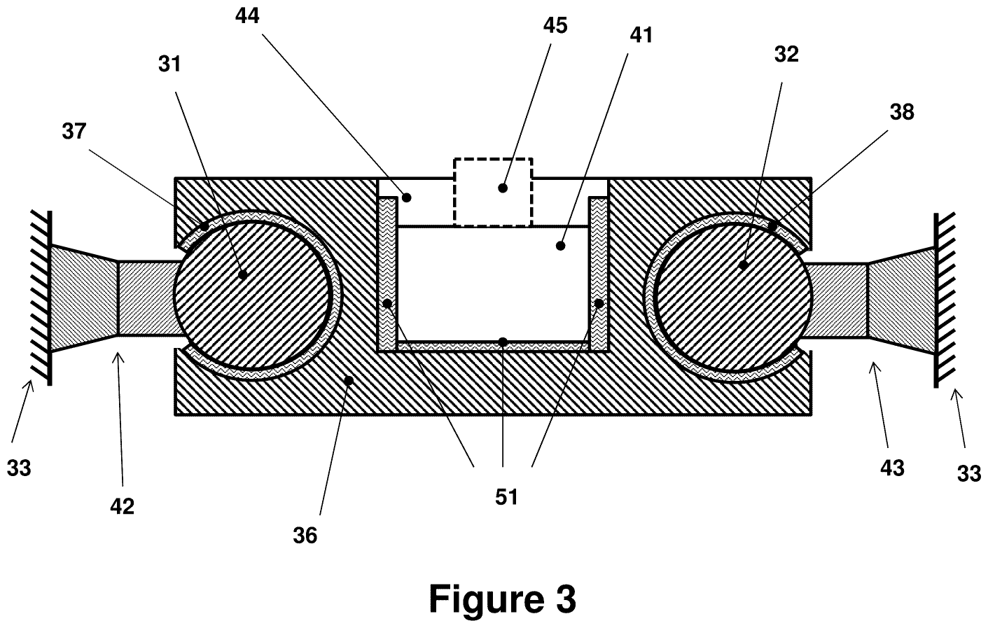

An isometric view of a first mechanical shock testing machine embodiment 30 is shown in FIG. 2A and a close-up view of its test carriage and platform is shown in FIG. 2B. The shock testing machine 30 is horizontally installed so that it can accommodate relatively long rails as it will be described but may also be vertically installed when relatively low acceleration levels and durations are involved. The rails 31 and 32 are attached to the machine base (foundation) structure 33 (shown as ground) by rigid support structures 34 and 35. A carriage member 36 is provided with sleeve bearings 37 and 38 as shown in the cross-sectional view of FIG. 3 to travel along the rails 31 and 32 freely with minimal friction.

During shock loading test to be described later, the carriage member 36 is accelerated to a desired velocity from its right-most position in the direction of the arrow 39 as shown in FIG. 2A using one of the methods to be described. For the sake of safety, a proper shock absorber 40 is provided on the rigid support structure 35 in case braking elements fail to bring the carriage member 36 and the test platform 41 to which the object to be tested in shock loading is attached to a stop. The carriage member 36 is provided with the pocket 44 (FIGS. 2B and 3) for positioning the test platform 41. The pocket 44 may be provided with a low friction lining 51, FIG. 3, to allow the test platform 41 to slide inside the pocket 44 with minimal friction. The pocket 44 may also be provided with side lips (not shown) to prevent the test platform from accidentally coming out of the pocket while moving along the length of the pocket.

As can be seen in the cross-sectional view of FIG. 3, the carriage member 36 rides over the rails 31 and 32 with the provided bearing sleeves 37 and 38, respectively. The rails 31 and 32 are attached to the machine structure 33 (shown only as the ground) by support structures 42 and 43, respectively. The support structures 42 and 43 can be made out of solid steel or stainless steel to be very rigid. The machine structure 33 can also be made out of heavy structural steel and is firmly attached to a concrete slab to withstand the testing shock loading with negligible vibration.

As can be seen in the cross-sectional view of FIG. 3, the rail bearings are positioned in the carriage member 36 such that the center of mass of the carriage member 36 is positioned essentially in the plane of long axes of the rails 31 and 32 so that as the carriage member 36 is being subjected to shock testing deceleration pulse, the carriage member would not tend to tip over. In addition, the test platform 41 inside the pocket 44 of the carriage member 36 is used to carry the test objects, such as component 45 shown with dashed lines, to which the test objects are firmly attached so that they would experience essentially the same shock loading as the test platform 41 during testing as described later.

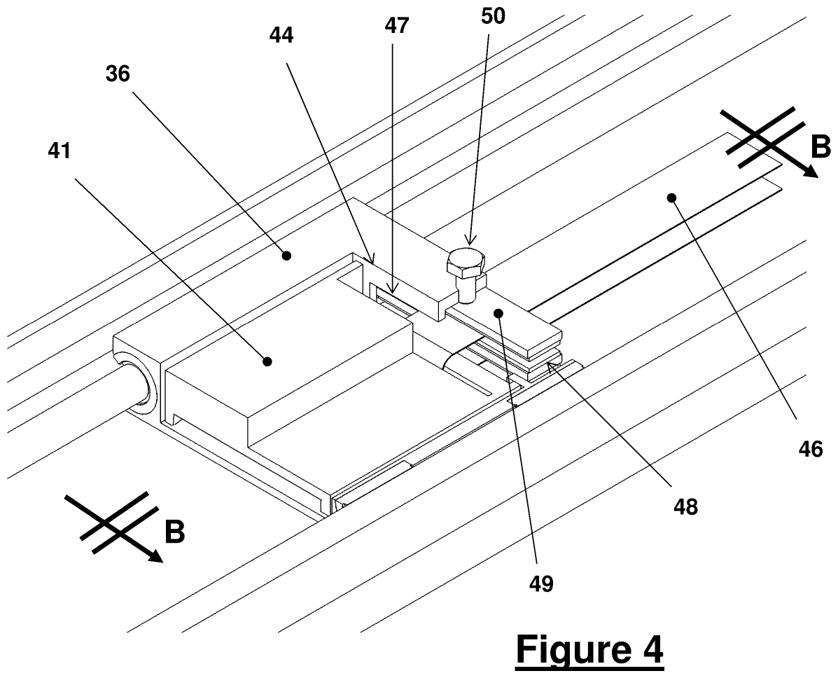

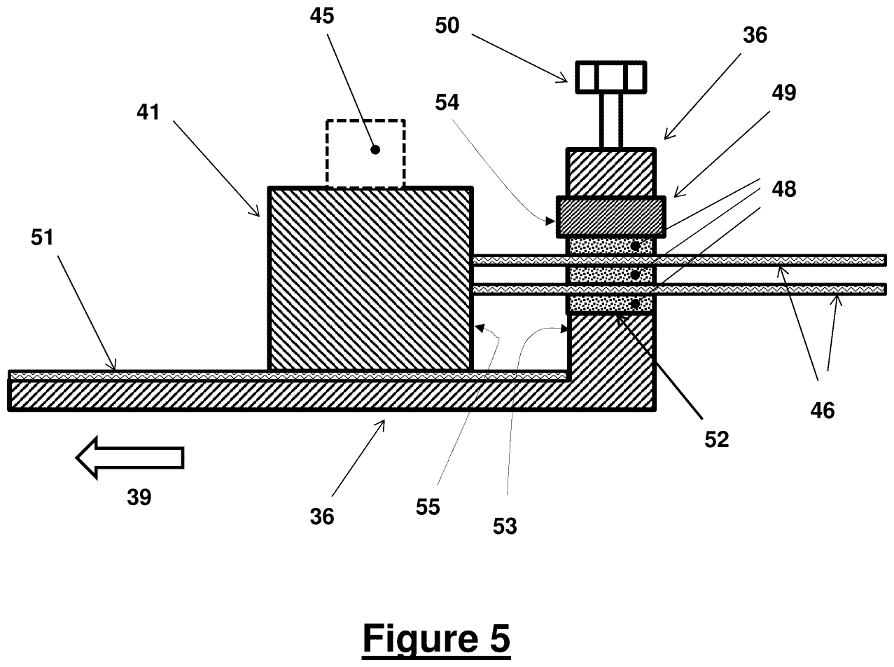

FIG. 4 illustrates a close-up isometric view of the test carriage and platform of the mechanical shock testing machine embodiment 30 of FIG. 2B with a cut-away view of the braking mechanism section of the machine. As can be seen in the cut-away section of the FIG. 4, the test platform 41 is provided with at least one braking strip member 46, which is fixedly attached to the back of the test platform as viewed in the isometric view of FIG. 4 and the cross-sectional view B-B of FIG. 5. High friction pads 48 are then provided between the braking strip members 46 and between the braking strip members 46 and the surface 52 of the carriage member 36 and the pressure plate 49 as shown in more detail in the cross-sectional view of FIG. 5. The section 47 of the carriage member 36 is provided for housing the braking mechanism of the present mechanical shock loading machine embodiment 30 of FIG. 2B. The pressure adjustment screws 50, FIGS. 4 and 5, are used to adjust the braking pads 48 pressure against the surfaces of the at least one braking strip member 46 to allow the friction force resisting its movement relative to the carriage member 36 to be adjusted.

In general, the brake pads 48 are fixedly attached to the surface 52 and the bottom surface of the pressure plate 49 using commonly used adhesives. Stops (not shown for the sake of clarity) are also provided on the side 53 of the carriage member 36 and the side 54 of the pressure plate to prevent the brake pads 48 that are positioned between the strip members 46 from sliding out as the strip members are pulled (to the left as viewed in FIG. 5) by the test platform 41 during the acceleration shock loading tests.

To perform shock testing, the components 45 to be tested are fixedly attached to the test platform 41, FIGS. 3 and 5. The pressure adjustment screws 50 are then used to adjust the pressure on the braking pad 48 to the level that is needed to achieve the required friction force level on the braking strip members 46 as the test platform begins to move to the left relative to the carriage member 36 as described later during the acceleration shock loading test. The friction force adjustment can be done by providing a force gage assembly (not shown) between the surface 55 of the test platform 41 and the surface 53 of the carriage member 36, which is provided with an adjustable wedging member to tend to move the test platform 41, i.e., to separate the two surfaces 55 and 53. The provided friction force is then measured as the test platform begins to move. Such screw adjusted wedging mechanisms are well known in the art and are used to open gaps or pry open space between certain structures. The friction force may obviously be also adjusted by trial and error with the application of short duration acceleration pulses as described below.

The carriage member 36 is then accelerated to a desired velocity from its right-most position in the direction of the arrow 39 as shown in FIGS. 2A and 5 using one of the methods to be described. Then as can be seen in the isometric view of FIG. 2B, the side 56 of the carriage member 36 reaches the stop 57 and essentially comes to a quick stop. The stop 57 is provided on the shock loading machine structure 33 and can be provided with a shock absorber or other kinetic energy absorbing members to prevent the carriage member 36 from bouncing back as it is brought to a stop.

The level of the force that accelerates the carriage member 36 and its duration are selected to achieve the desired carriage member velocity as the side 56 of the carriage member reaches the stop 57.

Now as the carriage member 36 comes to a stop against the stop 57, the kinetic energy stored in the test platform 41, the braking strip members 46, and the attached components 45 that are being tested (hereinafter referred to as just the test platform) would continue to move in the direction of the arrow 39, FIGS. 2A and 5, since they are not affected by the stopping of the carriage member 36. However, the friction forces produced by the brake pads 48 on the braking strip members 46 would begin to decelerate the test platform 41 until it comes to a complete stop, i.e., until all its kinetic energy is converted to heat, i.e., by the work done by the friction force.

It is appreciated that if the initial velocity of the test platform 41 as the carriage member 36 comes to a stop and the friction force begins to act on it is V₀; the total mass of the test platform 41 (including those relatively small masses of the braking strip members 46 and the attached components 45) is m; and the friction force generated by the brake pads 48 on the braking strip members 46 is F_{f}, then equating the initial kinetic energy of the moving mass work done by the friction force to bring the moving mass to stop yields the following expression:

$$( 1 / 2 ) {mV}_{0}^{2} = {F}_{f} d \qquad ( 1 )$$

where d is the total distance travelled by the mass m inside the pocket 44 of the carriage member 36. Thus, the total distance d travelled by the mass m inside the pocket 44 is given by:

$$d = \frac{{{mV}_{0}}^{2}}{2 {F}_{f}} \qquad ( 2 )$$

It is also appreciated that since the friction force F_{f} is essentially constant, therefore the test platform 41 (mass m) is subjected to a constant deceleration a given by:

$$a = \frac{{F}_{f}}{m} \qquad ( 3 )$$

And the duration of time t that the test platform 41 (mass m) is subjected to the acceleration a, equation (3) becomes:

$$t = \frac{{V}_{0}}{a} = \frac{{mV}_{0}}{{F}_{f}} \qquad ( 4 )$$

It is appreciated the braking mechanism described above would apply an essentially constant deceleration pulse (shock) indicated by the equation (3) to the object 45 that is being tested as described above, FIGS. 2A, 4 and 5. In addition, the duration of the deceleration pulse can be increased by simply increasing the initial velocity V₀ of the carriage member 36 as the side 56 of the carriage member 36 reaches the stop 57 and essentially comes to a quick stop.

With the disclosed mechanical shock testing machine embodiment 30, relatively long deceleration pulse durations can be achieved since the length of the pocket 44 (length is considered to be measured in the direction of the arrow 39, FIGS. 2A and 5) can be made long enough to accommodate the acceleration duration. For example, if the shock loading acceleration is a=500 G with a duration of t=3 milliseconds, then the total distance d that the test platform 41 travels inside the pocket 44 becomes:

$$d = 0.5 {at}^{2} = ( 0.5 ) ( 500 \times 9.8 ) {( 3 \times {10}^{- 3} )}^{2} = 0.022 m$$

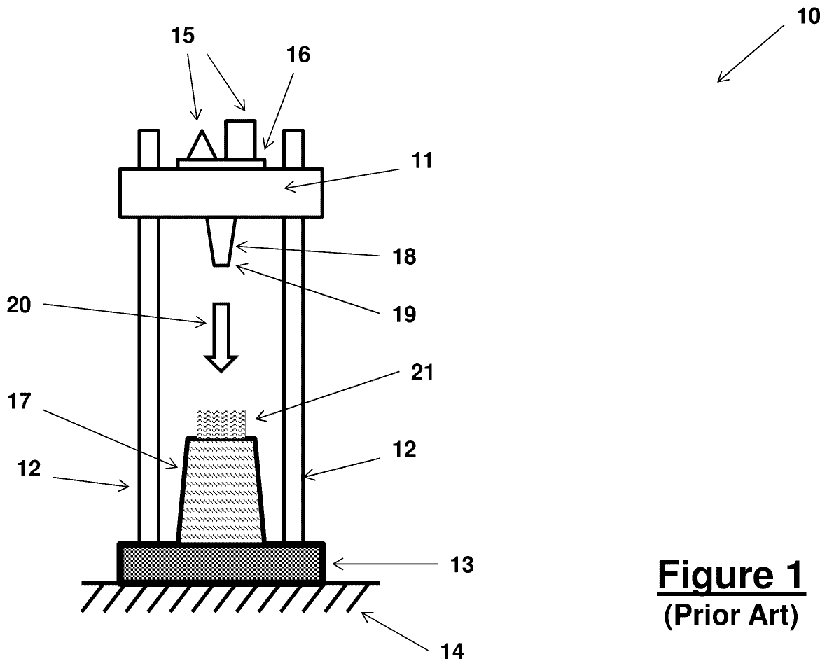

which is very small. This is in contrast with the amount of deformation that impact pads element 21 of the prior art mechanical testing machines shown in FIG. 1 can practically provide as was previously described, thereby significantly limiting the duration of deceleration pulses that the prior art mechanical shock testing machines can provide. That is in addition to the fact that currently available impact pads cannot provide a constant deceleration rate.

However, it is appreciated that when the required acceleration level is higher and particularly when the required acceleration duration is longer, the total distance d that the test platform 41 has to travel inside the pocket 44 becomes significant, thereby requiring a significantly longer pocket 44 (length is considered to be measured in the direction of the arrow 39, FIGS. 2A and 5) and thereby significantly heavier carriage member 36. The heavier carriage member 36 would in turn require a significantly higher applied force to accelerate the carriage member to the required velocity V₀ as was previously described. For example, if the shock loading acceleration is increased to a=1500 G from the above a=500 G and its duration is increased to t=10 milliseconds from t=3 milliseconds, then the total distance d that the test platform 41 travels inside the pocket 44 becomes:

$$d = 0.5 {at}^{2} = ( 0.5 ) ( 1500 \times 9.8 ) {( 10 \times {10}^{- 3} )}^{2} = 0.735 m$$

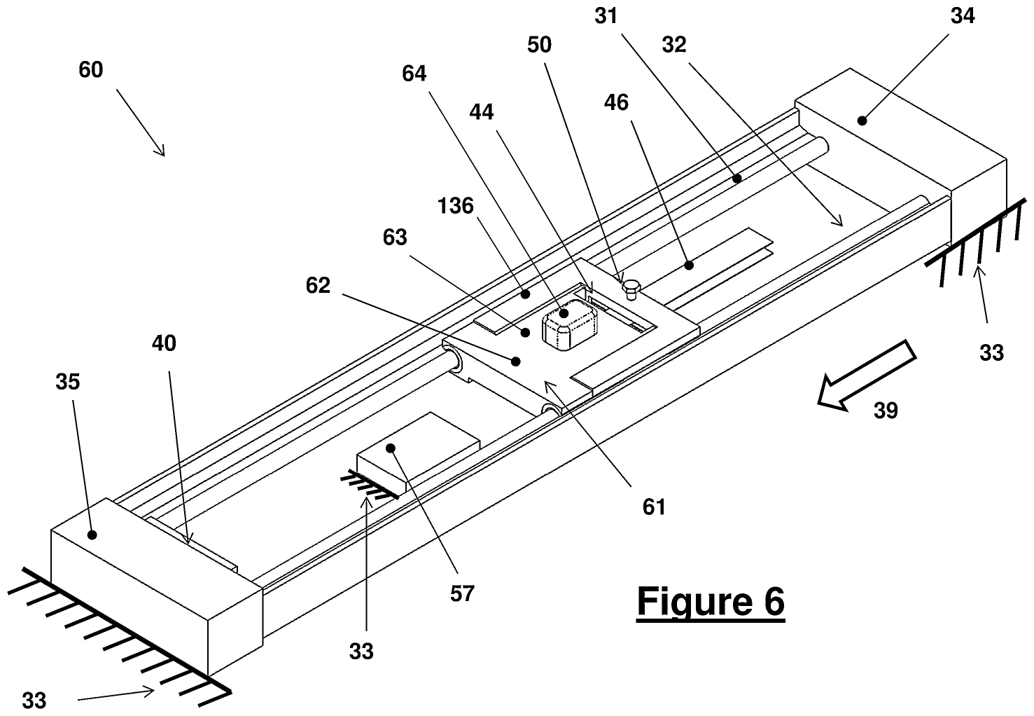

which is over 30 times longer that the above case and that would result in a very heavy carriage member. The mechanical shock loading machine embodiment 30 of FIG. 2A may, however, be modified to address this shortcoming. Such a modified mechanical shock loading machine embodiment is shown in the isometric view of FIG. 6 and is identified as the embodiment 60.

The isometric view of the modified mechanical shock loading machine embodiment 60 is shown in the isometric view of FIG. 6. All components of the shock loading machine embodiment 60 of FIG. 6 are identical to those of the embodiment 30 of FIG. 2A except for its test platform 61 (41 in FIGS. 2A and 2B). In the mechanical shock loading machine embodiment 60, the test platform 61 is seen to consist of a frontal portion 62 and a tail portion 63. The tail portion 63 of test platform 61 is configured to ride in the pocket 44 of the carriage member 136 as was previously described for the test platform 41 of the mechanical shock loading machine embodiment 30 of FIG. 2A. The frontal portion 62 of the test platform 61 is constricted to ride on the rails 31 and 32 with the provided bearings bearing sleeves 37 and 38 as shown in the cross-sectional view of FIG. 3.

To perform shock testing, the components 64 to be tested are fixedly attached to the test platform 61, FIG. 6. The pressure adjustment screws 50 are then used to adjust the pressure on the braking pad 48 to the level that is needed to achieve the required friction force level on the braking strip members 46 as the test platform begins to move to the left relative to the carriage member 136 as described later during the acceleration shock loading test, FIGS. 5 and 6. The friction force adjustment can be done as was previously described for the embodiment 30 of FIG. 2A by providing a force gage assembly (not shown) between the surface 55 of the test platform 41 (61 in FIG. 6) and the surface 53 of the carriage member 136, which is provided with an adjustable wedging member which tends to separate the two surfaces. The provided friction force is then measured as the test platform begins to move. Such screw adjusted wedging mechanisms are well known in the art and are used to open gaps or pry open space between certain structures. The friction force may obviously be also adjusted by trial and error with the application of short duration acceleration pulses as was previously described for the embodiment 30 of FIG. 2A.

The carriage member 136 is then accelerated to a desired velocity from its right-most position in the direction of the arrow 39 as shown in FIG. 6 using one of the methods to be later described. Then as can be seen in the isometric view of FIG. 6, the frontal side 56 (positioned under the frontal section 62 of the test platform 61 in FIG. 6 but clearly shown in FIG. 2B) of the carriage member 136 reaches the stop 57 and essentially comes to a quick stop. The stop 57 is provided on the shock loading machine structure 33 and can be provided with a shock absorber or other kinetic energy absorbing members to prevent the carriage member from bouncing back as it is brought to a stop.

The level of the force that accelerated the carriage member 136 and its duration are selected to achieve the desired carriage member velocity as the side 56 of the carriage member reaches the stop 57.

Now as the carriage member 136 comes to a stop against the stop 57, the kinetic energy stored in the test platform 61, the braking strip members 46, and the attached components 64 that are being tested (hereinafter referred to as just the test platform) would continue to move in the direction of the arrow 39, FIG. 6, since they are not affected by the stopping of the carriage member 136. However, the friction forces produced by the brake pads 48 on the braking strip members 46, FIG. 5, would begin to decelerate the test platform 61 until it comes to a complete stop, i.e., until all its kinetic energy is converted to heat, i.e., by the work done by the friction force.

In the isometric view of the mechanical shock loading machine embodiment 60, the test platform 61 is shown to consist of a frontal portion 62 and a tail portion 63, which is configured to ride in the pocket 44 of the carriage member 136. In general, the tail portion 63 is provided so that as the carriage member 136 together with the test platform are accelerated to the aforementioned desired velocity V₀ before the carriage member 136 is stopped, the test platform would undergo minimal lateral movements relative to the carriage member 136. It is therefore appreciated that the length of engagement between the tail section 63 of the test platform 61 and the pocket 44 does not have to be long to serve this purpose. It is also appreciated that when the lateral movements are not of concern, particularly for tests requiring lower velocities V₀, then the tail section 63 may be eliminated.

It is appreciated that since the mechanical shock loading machine configuration of the embodiment 60 of FIG. 6 does not limit the length of travel of the test platform 61 to the length of the pocket 44 of the carriage member 136 as was described for the embodiment 30 of FIG. 2A and that since the rails 31 and 32 can have any required length past the stop 57, therefore the distance d, equation (2), that the test platform 61 can travel before coming to a stop essentially unlimited. As a result, for a specified shock acceleration level, the shock duration would only be limited to the initial velocity V₀, equation (4), when the carriage member 136 is brought to a stop by the stop 57.

In the shock loading machine embodiment 60 of FIG. 6, the test platform 61 is shown to ride on the rails 31 and 32 over which the carriage member 136 also rides. However, in many shock loading machines, it is highly desirable that the test platform 61 be as lightweight and therefore small as possible. In such cases, the test platform may be provided with its own rails, usually positioned between the rails 31 and 31, thereby allowing the test platform to be narrower and also provide higher ratio between the rail contact length and the distance between the rails for higher stability during its motion before and during deceleration.

In the above mechanical shock loading machine embodiments, the carriage members (136 and 36 in the embodiments 30 and 60 of FIGS. 2A and 6, respectively) are accelerated at a relatively slow rate from a stationary position to a desired velocity, at which time the carriage member is suddenly stopped to allow the test platforms (41 and 61 in the embodiments 30 and 60 of FIGS. 2A and 6, respectively) to be decelerated at a predetermined rate and for a prescribed duration. The task of accelerating the carriage members may be accomplished using several methods, including the following three methods.

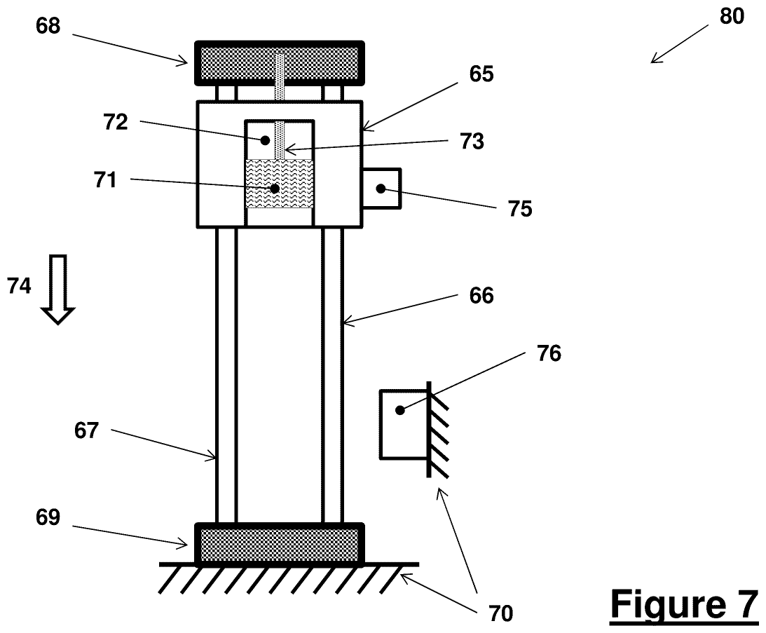

The first method of accelerating the carriage member of the mechanical shock testing machine to the desired velocity is shown in the schematic of FIG. 7. This embodiment is identified as the embodiment 80 as can be seen in FIG. 7. In this method, the mechanical shock loading machine is installed vertically. This method is used for cases in which relatively low shock (deceleration) levels or short shock durations are required for the test. In the embodiment of FIG. 7, the carriage member 65 (36 and 136 in the embodiments of FIGS. 2A and 6, respectively) similarly rides on vertically mounted rails 66 and 67. The rails are mounted firmly in a top and a bottom supports 68 and 69, respectively. The bottom support member 69 is generally large and massive enough to provide stability and may also be firmly attached to a properly sized foundation or machine structure 70 (shown as ground). The carriage member 65 is shown to be similarly provided with the pocket 72 (44 in the embodiments of FIGS. 2A and 6), within which the test platform 71 (41 and 61 in the embodiments of FIGS. 2A and 6, respectively) would ride as was previously described. The at least one braking strip members 73 (46 in the embodiments of FIGS. 2A and 6) and the braking mechanism elements (not shown) are provided similar to the embodiments of FIGS. 2A and 6.

In the schematic of the embodiment 80 of FIG. 7, the test platform 71 is shown to be configured as shown in the embodiment 30 of FIG. 2A, i.e., it only rides in the provided pocket 72 of the carriage member 65. It is, however, appreciated that the test platform 71 may also be configured as shown in the embodiment 60 of FIG. 6 to ride on the rails 66 and 67.

To perform a shock loading test, the object to be tested is fixedly attached to the test platform 71. The carriage member 65 is then released from a predetermined height, so that as it is accelerated down in the direction of the arrow 74 under gravitational acceleration, at the time that the carriage side member 75 comes to a stop against the stop member 76 (which is fixedly attached to the machine structure 70), it has gained the desired initial velocity V₀, equation (4). It is appreciated that the height of travel of the carriage member 65 under the gravitational acceleration determines the initial velocity V₀ as was previously indicated. In general, the carriage member 65 is held to the top support 65 at the desired height by a quick release mechanism (not shown), which is then released by the pulling of a cable or string after removing its safety lock pin. Such quick release mechanisms with safety pins are well known in the art. Once the carriage member 65 has been stopped by the stop 76, the test platform 71 together with its attached test object is decelerated by the provided friction forces acting on the at least one braking strip 73 as was described for the embodiments 30 and 60 of FIGS. 2A and 6.

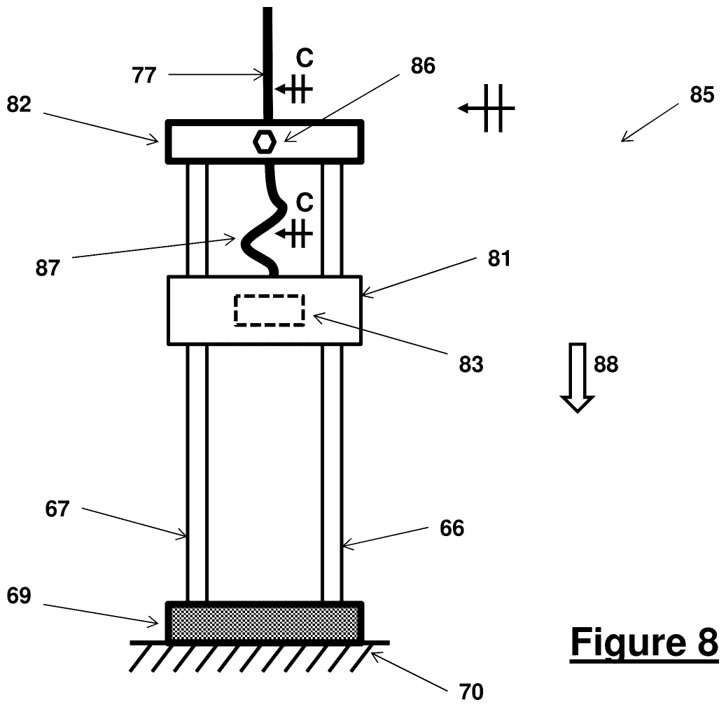

A modified version of the vertical shock loading machine embodiment 80 is shown in FIG. 8. The mechanical shock loading machine is similarly installed vertically and is identified as the embodiment 85. All components of the shock loading machine embodiment 85 are identical to those of the embodiment 80 of FIG. 7 except for its carriage assembly 81 and the top support structure 82. In the embodiment 85, the carriage member 81 similarly rides on vertically mounted rails 66 and 67. The rails are mounted firmly in a top and a bottom supports 82 and 69, respectively. The bottom support member 69 is generally large and massive enough to provide stability and may also be fixedly attached to a properly sized foundation or machine structure 70 (shown as ground).

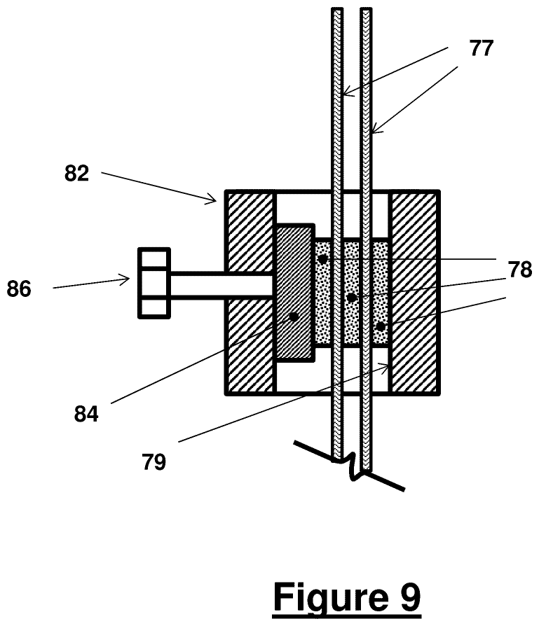

In the mechanical shock loading machine embodiment 85 of FIG. 8, the carriage member 81 also serves as the test platform to which the object 83 that is to be tested is fixedly attached. The at least one braking strip members 77 (73 in the embodiment of FIG. 7) and the braking mechanism elements, which are similar to those shown in the cross-sectional view B-B of FIG. 5, are as shown in the cross-sectional view C-C of FIG. 9 as provided on the top support 82.

As can be seen in the cut-away section of the FIG. 9, the top support member 82 is provided with at least one braking strip member 77, which is fixedly attached to the back of the carriage member 81 as can be seen in FIG. 8. High friction pads 78 are then provided between the braking strip members 77 and between the braking strip members 78 and the surface 79 of the carriage member 82 and the pressure plate 84 as shown in more detail in the cross-sectional view of FIG. 9. The pressure adjustment screws 86, FIGS. 8 and 9, are used to adjust the braking pads 84 pressure against the surfaces of the at least one braking strip member 77 to allow the friction force resisting its movement relative to the top support member 82 to be adjusted.

To perform a shock loading test, the object to be tested 83 is fixedly attached to carriage member 81, FIG. 8. The carriage member 81 is then raised as shown in FIG. 8 to allow the section 87 of the at least one braking strip member 77 between the top member 82 and the carriage member 81 to slacken the desired length to allow the carriage member 81 to travel down in the direction of the arrow 88 the desired distance before the at least one braking strip member 77 becomes taut and begins to be pulled through the braking pads 78, FIG. 8, and the carriage member 81 begins to be decelerated as was described for the embodiments 30 and 60 of FIGS. 2A and 6, respectively.

To perform a shock loading test, the carriage member 81 is therefore released from a predetermined height, so that as it is accelerated down in the direction of the arrow 88 under gravitational acceleration, at the time that the at least one braking strip member becomes taut, it has gained the desired initial velocity V₀, equation (4). It is appreciated that the height of travel of the carriage member 81 under the gravitational acceleration determines the said initial velocity V₀ as was previously indicated. In general, the carriage member 81 is held to the top support 82 at the desired height by a quick release mechanism (not shown), which is then released by the pulling of a cable or string after removing its safety lock pin. Such quick release mechanisms with safety pins are well known in the art. Once the section 87 of the at least one braking strip member 71 has become taut, the carriage member 81 together with its attached test object 83 are decelerated by the provided friction forces acting on the at least one braking strip 73 as was described for the embodiments 30 and 60 of FIGS. 2A and 6.

In mechanical shock testing machines, particularly when higher acceleration shock loading and durations are required, other means such as pre-tensioned bungee cords or pneumatic or electric drives may be used to achieve significantly higher carriage member velocities, for example for the embodiments 30, 60 and 80 of FIGS. 2A, 6 and 7, respectively. The aforementioned second and third methods used for this purpose are intended to refer to the methods of using pre-tensioned bungee cords to accelerate the carriage members of the various embodiments as described below.

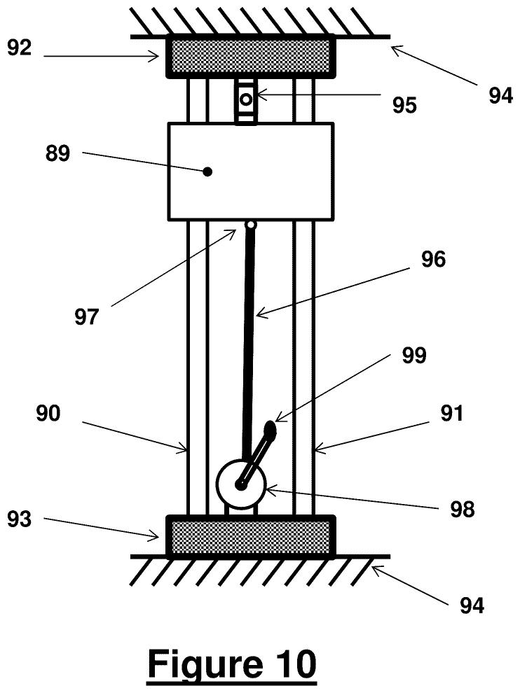

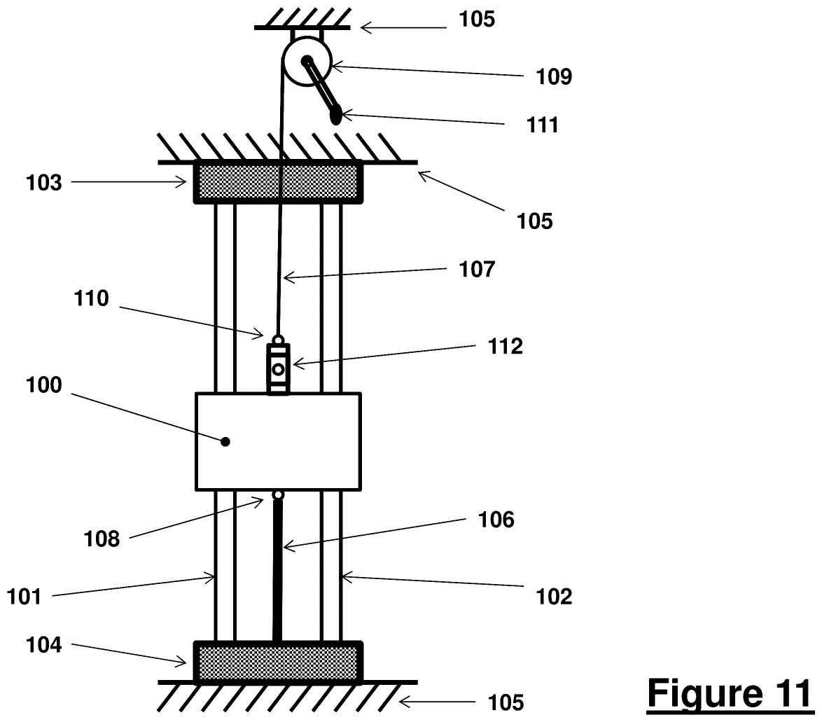

The indicated second and third methods are very similar and both involves the release of the mechanical shock loading machine carriage member after pre-tensioning at least one bungee that connects the carriage member to the (usually base) structure of the machine. The main difference between the two methods is the process of pre-tensioning the bungees. The second and methods of pre-tensioning at the at least on bungee are shown in the schematics of FIGS. 10 and 11, respectively, and are shown how the methods apply to shock loading machine embodiments by illustrating how they are configured for accelerating carriage members.

The second method of accelerating the carriage member of the mechanical shock testing machine to the desired velocity is shown in the schematic of FIG. 10. In this schematic of the shock loading machine, only the mechanism of accelerating the carriage member 89 using this method is shown. In this method, the mechanical shock loading machine may be installed vertically, in which case the pre-tensioned bungee(s) provides additional downward accelerating force in addition to the force due to the gravitational acceleration. The mechanical shock loading machine may also be installed horizontally, in which case the only force that would accelerate the carriage member is provided by the pre-tensioned bungee(s). It is appreciated that the horizontally installed shock loading machines have the advantage of essentially unlimited rail travel over vertically installed machines and are therefore not limited to low G acceleration and relatively short duration tests.

In shock loading machines using this method of accelerating the carriage member to the desired velocity, the carriage member 89 still rides on mounted rails 90 and 91. The rails are mounted firmly in a top and a bottom supports 92 and 93, respectively. The top and bottom support members 92 and 93 are generally rigid and massive enough to provide stability and may also be fixedly attached to properly sized foundation or machine structure 94 (shown as ground).

The carriage member 89 is initially attached to the support member 92 by a quick release mechanism 95 as shown in FIG. 10. Such quick release mechanisms with provided safety arming pin or the like are widely used and known in the art. The at least one bungee cord 96 is then attached to the opposite side of the carriage member 89 on one end, usually via an eyelet 97, and the other end to a collecting winch 98. The winch 98 is used to collect the bungees 96 and is operated either manually by the rotation of the handle 99 or via an electric motor via a speed reduction gearing commonly used in such winches. A load cell may also be provided, for example between the quick release mechanism and the support 92, to measure the force applied by the bungees to the carriage member as the winch winds the bungees and thereby increases its pre-tension and thereby provide the means of adjusting it to the desired level.

It is appreciated that in many cases, the winch may be attached past the support 93 to allow long enough bungee cords to be used to accelerate the carriage member 89 long enough to achieve high initial velocity V₀, equation (1), before the friction mechanisms begins to decelerate the test platform (41, 62 and 71 FIGS. 2A, 6 and 8) of the machine.

To perform a shock loading test, the object to be tested is fixedly attached to the test platform (41, 62 and 71 FIGS. 2A, 6 and 8). The carriage member 89 is fixed to the support 92 via the quick release mechanism 95. The winch 98 is then used to collect the bungee(s) to pre-tension it to the desired force level as measured by the aforementioned force gage. The quick release mechanism would then release the carriage member 89 by the operator, usually by pulling a release cord after removing a safety pin that prevents accidental releasing of the quick release mechanism. The shock loading machine (e.g., embodiments 30, 60 and 80 of FIGS. 2A, 6 and 7) would have their shock loading function as was previously described for each of the embodiments.

The third method of accelerating the carriage member of the mechanical shock testing machine to the desired velocity is shown in the schematic of FIG. 11. In this schematic of the shock loading machine, only the mechanism of accelerating the carriage member 100 using this method is shown. Similar to the embodiment of FIG. 10, the mechanical shock loading machine may be installed vertically, in which case the pre-tensioned bungee(s) provides additional downward accelerating force in addition to the force due to the gravitational acceleration. The mechanical shock loading machine may also be installed horizontally, in which case the only force that would accelerate the carriage member is provided by the pre-tensioned bungee(s). It is appreciated that the horizontally installed shock loading machines have the advantage of essentially unlimited rail travel over vertically installed machines and are therefore not limited to low G acceleration and relatively short duration tests.

In shock loading machines using this method of accelerating the carriage member to the desired velocity, the carriage member 100 still rides on mounted rails 101 and 102. The rails are mounted firmly in a top and a bottom supports 103 and 104, respectively. The top and bottom support members 103 and 104 are generally rigid and massive enough to provide stability and may also be fixedly attached to properly sized foundation or machine structure 105 (shown as ground).

The carriage member 100 is initially held in its “neural” position by the at least one bungee cord 106 on one end and the winch cable 107 on the other as shown in FIG. 11. The winch 109 is attached to the machine structure or its foundation 105 as shown in the schematic of FIG. 11. In this positioning of the carriage member 100, the at least one bungee cord 106 and the winch cable 107 are essentially not tensioned. The at least one bungee cord is attached on one end to the carriage member 100 via the eyelet 108 and to the support 104 (or other further positioned anchoring location—not shown) on the other end. The winch cable 107 is also attached to the carriage member 100 via an eyelet 110 and the quick release mechanism 112. Such quick release mechanisms with provided safety arming pin or the like are widely used and known in the art. A load cell may also be provided (not shown), for example between the quick release mechanism 112 and the carriage member 100, to measure the force applied by the bungees to the carriage member as the winch winds the winch cable to pre-tension the bungees 106 for a shock loading test.

The winch 109 is used to collect the winch cord 107, pulling the carriage member 100 towards it, thereby extending the at least one bungee cord 106 and storing mechanical potential energy in it due to its elastic deformation. It is appreciated that the winch 109 may be either operated manually by the rotation of the handle 109 or via an electric motor via a speed reduction gearing (not shown) commonly used in such winches.

To perform a shock loading test, the object to be tested is fixedly attached to the test platform (41, 62 and 71 FIGS. 2A, 6 and 8). The bungees 106 and the winch cord 107 are attached to the carriage member 100 as shown in FIG. 11. The winch 98 is then used to collect the winch cable 107, moving the carriage member 100 towards the top support 103 and thereby extending the bungees 106. The bungees 106 are then extended to the desired tension level as measured by the aforementioned force gage. Then to perform the test, the operator would release the quick release mechanism, usually by pulling a release cord after removing a safety pin prevents accidental releasing of the quick release mechanism. The carriage member 100 is then released and the shock loading machine (e.g., embodiments 30, 60 and 80 of FIGS. 2A, 6 and 7) would function as was previously described for each of the embodiments.

It is appreciated that in many cases, the winch 109 and the bungees may be attached past the supports 103 and 104 to allow long enough bungee cords to be used to accelerate the carriage member 100 long enough to achieve high initial velocity V₀, equation (1), before the friction mechanisms begin to decelerate the test platform (41, 62 and 71 FIGS. 2A, 6 and 8) of the machine.

In the above embodiments, the friction force adjustment of the friction mechanisms is shown to be achieved by pressure adjustment screws (50 in FIGS. 4-6 and 86 in FIGS. 8 and 9). In practice, however, it is best to use an adjustable quick release mechanism, such as the mechanism used in locking plyers, to enable the user adjust the braking force as was described for the embodiments and then to quickly release the braking forces to reset the shock loading machine after each test.

In the above embodiments, the braking strip members (46 and 73 in FIGS. 2A and 7, respectively) are shown to be thin (e.g., 0.010″ thick) and wide (e.g., 1.0″ wide) spring steel strips. It is, however, appreciated that one may use various cables or other elements for this purpose. It is also appreciated that the braking strips may also be provided with varying thicknesses, thereby causing the friction force and thereby the imparted deceleration of the test platform to vary and form a prescribed profile, for example, a nearly half sine or a smoothened trapezoidal profile.

It is appreciated by those skilled in the art that as it was previously indicated, to achieve relatively high shock loading acceleration and duration for shock loading machines, such as the shock loading machine embodiments 30 and 60 of FIGS. 2A and 6, respectively, it is highly desirable to make the test platform assembly (components 36 and 41 in the embodiment 30 of FIG. 2A and 136 and 61 in the embodiment 60 of FIG. 6) as light as possible so that it can be accelerated to higher speeds in shortest possible distance with relatively low (preloaded bungee or the like) force. In addition, by minimizing the mass of the test platform (61 in embodiment 60 of FIG. 6), the braking force that is required for its prescribed deceleration is also minimized.

It is appreciated that as it was previously described, for a prescribed shock loading acceleration level, the duration of the shock acceleration is increased by increasing the velocity of the test platform as the carriage member 136 is stopped by the stop 57, FIG. 6.

In addition, since the shock loading machine embodiments 30 and 60 of FIGS. 2A and 6, respectively, are installed horizontally, their test platform assembly (components 36 and 41 in the embodiment 30 of FIG. 2A and 136 and 61 in the embodiment 60 of FIG. 6) can only be accelerated by the aforementioned pre-tensioned bungee cords or pneumatic cylinders or even linear motors.

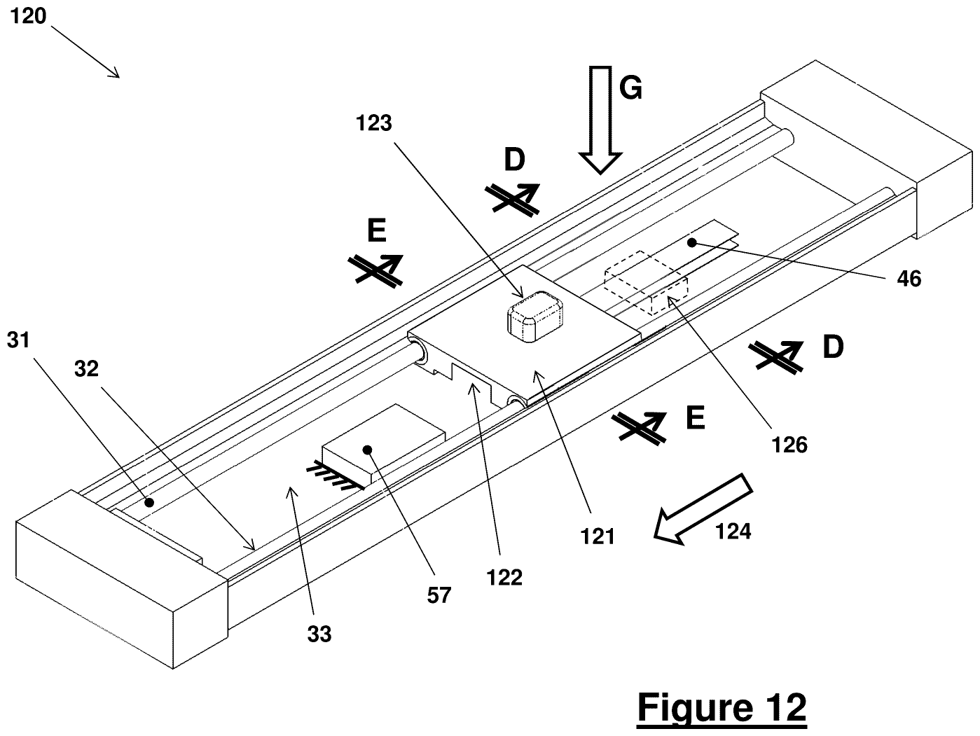

The above goals of minimizing the mass of the test platform assembly can be achieved by the following modification of the embodiment 60 of FIG. 6 shown in FIG. 12 and indicated as the embodiment 120 of the present invention.

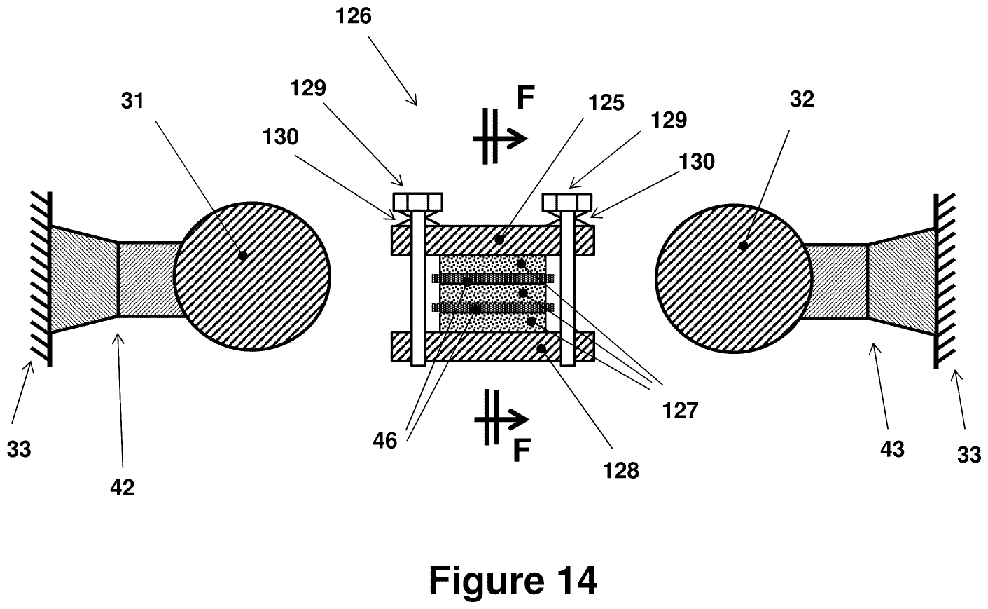

The isometric view of the modified mechanical shock loading machine embodiment 120 is shown in FIG. 12. All components of the shock loading machine embodiment 120 of FIG. 12 are identical to those of the embodiment 60 of FIG. 6 except for its test platform assembly, i.e., the carriage member 136 and the test platform 61, FIG. 6. In the modified mechanical shock loading machine embodiment 120 of FIG. 12, the test platform 121 (61 in FIG. 6), over which the components 123 to be tested are fixedly attached, rides on the rails 31 and 32 with the provided bearings bearing sleeves 37 and 38 as shown in the cross-sectional view of FIG. 3. The carriage member 136, FIG. 6, is then reduced in size and mass, as shown by dashed lines in FIG. 12 and indicated by the numeral 126 (hereinafter referred to as the “braking member”) and is engaged with the braking strip members 46 as shown in the cross-sectional view of FIG. 14 and described below. It is also noted that unlike the carriage member 136, the braking member 126 does not ride over the rails 31 and 32 and can therefore be made significantly smaller and lightweight. Similar to the embodiment 60 of FIG. 6, the provided at least one braking strip member 46 is also fixedly attached to the back of the test platform 121 as, for example, can be seen in the cut-away section of FIG. 4.

Test platform 121 is provided with groove 122, which runs along the length of the test platform and is wide and deep enough to allow test platform 121 to freely pass over the stop 57 as it moves in the direction of the arrow 124. The stop 57 is fixedly attached to the shock loading machine structure 33 and may be provided with a shock absorber or other kinetic energy absorbing members to prevent the braking member 126 from bouncing back as it is brought to a stop as is described later.

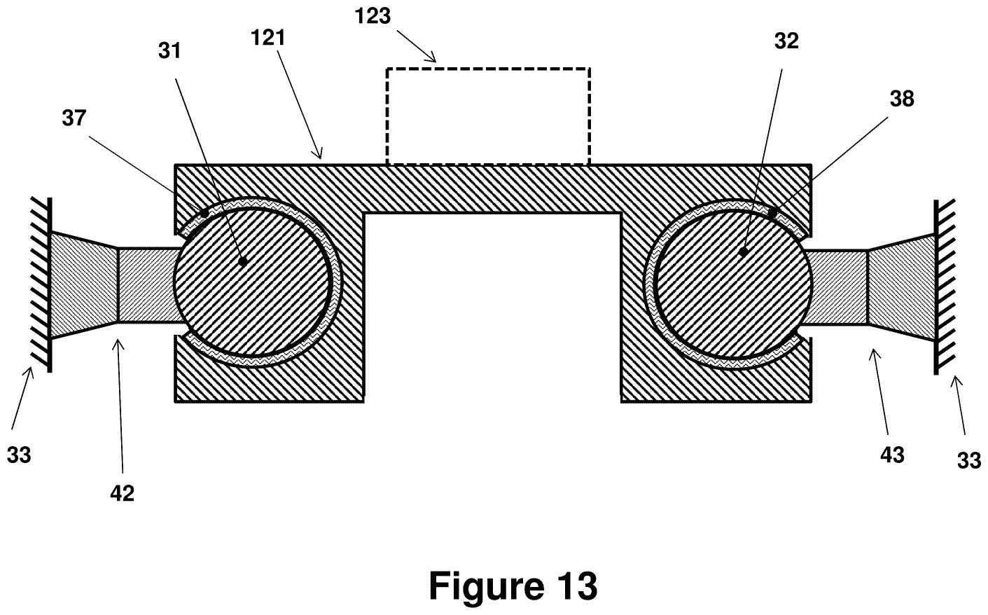

FIG. 13 illustrates the cross-sectional view E-E of the mechanical shock loading machine embodiment 120, FIG. 12, showing the cross-sectional view of the test platform 121. As can be seen in FIG. 13, the test platform 121 is provided with sleeve bearings 37 and 38 to travel along the rails 31 and 32 freely with minimal friction. As it was previously described for the embodiment 30 of FIG. 2A, the rails 31 and 32 are attached to the machine structure 33 (shown only as the ground) by support structures 42 and 43, respectively. The support structures 42 and 43 can be made out of solid steel or stainless steel to be very rigid. The machine structure 33 may also be made out of heavy structural steel and be firmly attached to a concrete slab to withstand the testing shock loading with negligible vibration.

FIG. 14 illustrates the cross-sectional view D-D of the mechanical shock loading machine embodiment of FIG. 12 showing the cross-sectional view of a typical braking member assembly 126 of the machine with two braking strip members 46 and three brake pads 127. The at least one braking strip members 46 and the braking mechanism elements, which are similar to those shown in the cross-sectional view of FIG. 9, are as shown in the cross-sectional view D-D of FIG. 14.

As can be seen in the cross-sectional view of FIG. 14, braking member assembly 126 is provided with two braking strip members 46, which is fixedly attached to the back of the test platform 121. High brake (friction) pads 127 are then provided between the braking strip members 46 and the surfaces of the relatively rigid top and bottom plates 125 and 128, respectively, within which the brake pads 127 are positioned.

Four pressure adjustment screws 129, FIG. 14, which pass through the holes in the corners of the top plate 125 and engage the threaded holes in the bottom plate 128 are provided. In general, relatively stiff springs, such as Bellville washers 130, are provided to assist in the adjustment of the desired pressure over the surfaces of brake pads 46 to obtain the desired friction force resisting the translation of the brake pads relative to the braking strip members 46.

To perform shock acceleration testing, the components 123 to be tested are fixedly attached to test platform 121, FIG. 12. The pressure adjustment screws 129 are then used to adjust the pressure on the brake pads 127 to the level that is needed to achieve the required friction force level on the braking strip members 46 as the test platform 121 begins to move to the left (in the direction of the arrow 124) relative to the braking member assembly 126 after it has been stopped by the stop 57, FIG. 14.

The friction force adjustment can be done as was previously described for the embodiment 30 of FIG. 2A by providing a force gage assembly (not shown) between the surface 55 of the test platform 41 (121 in FIG. 12) and the surface 53 of the carriage member 36, FIG. 5, which is provided with an adjustable wedging member which tends to separate the two surfaces. The provided friction force is then measured as the test platform begins to move. Such screw adjusted wedging mechanisms are well known in the art and are used to open gaps or pry open space between certain structures. The friction force may obviously be also adjusted by trial and error with the application of short duration acceleration pulses as was previously described for the embodiment 30 of FIG. 2A.

The test platform 121 is then accelerated to the desired velocity as was previously described for the embodiments 30 and 60 of FIGS. 2A and 6, respectively, preferably from its right-most position in the direction of the arrow 39 as shown in FIG. 12. Then, as can be seen in the isometric view of FIG. 12, the test platform would pass over stop member 57 and the braking member assembly 126 engages the stop member 57 and essentially comes to a quick stop. The stop member 57 and/or the is generally provided with shock/kinetic energy absorbing members, such as highly damped felt or elastomer layers, to prevent the carriage member 36 from bouncing back as it is brought to a stop.

The level of the force that accelerates the test platform 121 and its duration are selected to achieve the desired test platform velocity as the braking member assembly 126 engages the stop member 57.

Now as the braking member assembly 126 comes to a stop against the stop 57, the kinetic energy stored in the test platform 121, the braking strip members 46, and the attached components 123 that are being tested (also referred to as just the test platform) would continue to move in the direction of the arrow 39, FIG. 12, since they are not affected by the stopping of the braking member assembly 126. However, the friction forces produced by the brake pads 127 on the braking strip members 46, FIG. 14, would begin to decelerate the test platform 121 until it comes to a complete stop, i.e., until all its kinetic energy is converted to heat by the work done by the friction force.

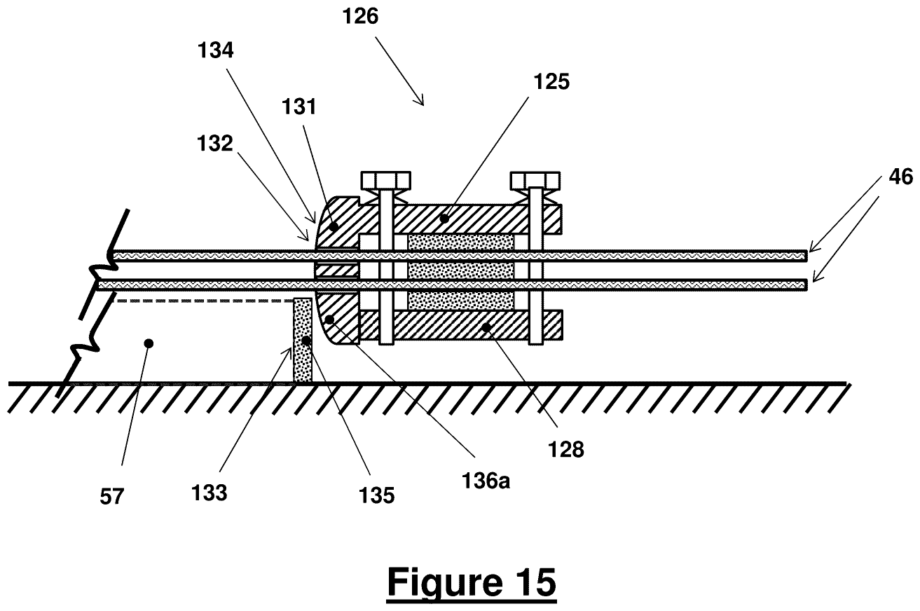

FIG. 15 illustrates the cross-sectional view F-F of the braking member 126 of the mechanical shock loading machine embodiment 120 of FIG. 12 as the braking member approaches the stop member 57. As can be seen in the cross-sectional view of FIG. 15, the top plate 125 is provided with a frontal portion 131, the surface 134 of which engages the frontal surface 133 of the stop member 57 during shock loading tests. In general, the surfaces 134 of the frontal portion 131 of the top member 125 of the braking member 126 and the engaging surface 133 of the stop member 57 are provided with matching flat or slightly matched curvatures to minimize lateral motion during engagement. A relatively thin shock absorbing material layer 135 is also provided to minimize rebounding of the braking member 126 upon its a frontal portion 131 coming into contact at high speed with the surface 133 of the stop member 57. Such shock absorbing material layers, such as felts, soft polymers, even putting material type layers that are used for impact shock absorption are well known in the art and depending on the total moving mass of the braking member 126 test platform assembly and their velocity at the time of the braking member and stop member engagement, proper material and thickness would be selected for the kinetic energy absorbing material layer 135. Two slots 132 are provided in the frontal portion 131 of the top member 125 to allow the braking strip members 46 to freely move through them.

It is appreciated that as can be observed in the cross-sectional view of FIG. 15, the surface 133 of the stop member 57 engages only the lower portion 136a of the surface 134 of the frontal portion 131, located below the lower braking strip member 46. The kinetic energy absorbing material layer 135 would distribute pressure over the engaging surfaces 133 and 134 of the stop member 57 and frontal portion 131 of the top plate 125, respectively. In shock loading tests in which the approaching speed of the braking member 126 towards the stop member 57 is relatively low, the aforementioned surface of contact between the two members is usually enough to absorb the kinetic energy of the braking member 126.

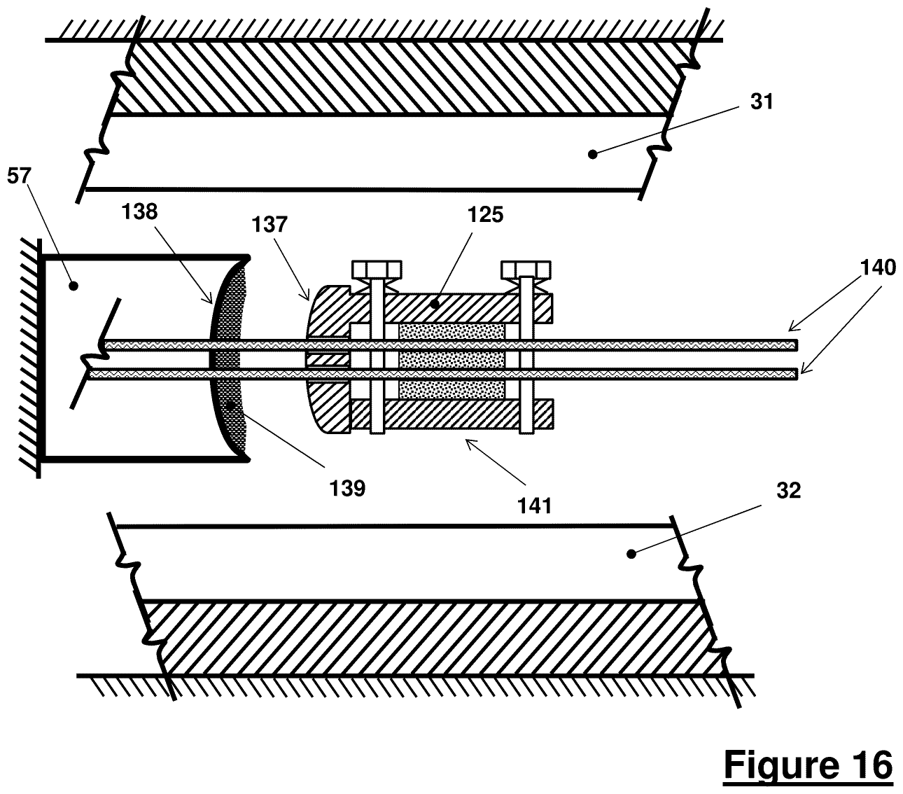

However, for higher speed shock loading test, i.e., when longer duration shock loading acceleration levels are required, the surface of contact between the braking member 126 and stop member 57 can be significantly increased by mounting the braking strip members 46 as shown in the top view “G” of FIG. 16 and indicated by the numeral 140, i.e., by having the braking strip members 46 be rotated 90 degrees about its long axis as viewed in FIG. 12 to as can be seen in FIG. 16 and indicated by the numeral 140. It is appreciated that the braking member 126 is similarly rotated 90 degrees as shown in the top view of FIG. 16 and indicated by the numeral 141. The braking member 141 is otherwise identical to the braking member 126 of FIG. 15.

It is appreciated that the modification of 90 degrees rotation of the braking member 126 and the braking strip members 46, FIGS. 12 and 15, to those of braking member 141 and braking strip members 140, FIG. 16, would result in the entire surface 137 of the frontal portion 131 of the top plate 125, FIG. 15, to engage the surface 138, FIG. 16, of the stop member 57. As a result, a relatively less surface pressure is generated as the braking member 141 engages the stop member 57. In addition, a shock absorbing member 137 is usually provided to eliminate or minimize bouncing back of the braking member 141 upon impact with the stop member 57.

The braking member of the mechanical shock loading machine embodiment 120 is shown in FIG. 16 with the alternative braking member 141 (126 in FIGS. 12, 14 and 15) and oriented braking strip members 140 (46 in FIGS. 12, 14 and 15). The resulting modified mechanical shock loading machine is then operated for shock loading tests as was previously described for the shock loading machine embodiment 120.

It is appreciated that shock loading tests at higher test platform (121 in FIG. 12) speeds, a significantly large impact areas are needed between the braking members (126 and 141 in FIGS. 14 and 16, respectively) and their stop members (57 in FIGS. 12 and 15-16) and their shock absorbing layers (135 and 139 in FIGS. 15 and 16, respectively) to control the rate at which the braking member is rapidly but smoothly brought to a stop, i.e., without rebounding and/or sharp deceleration rate.

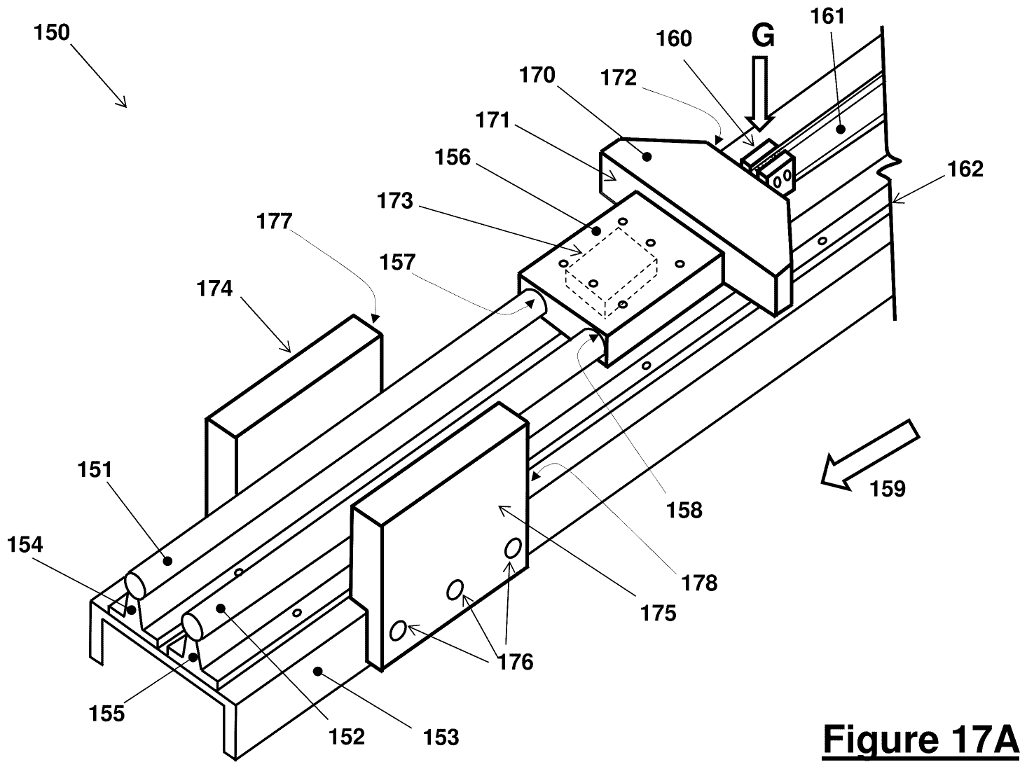

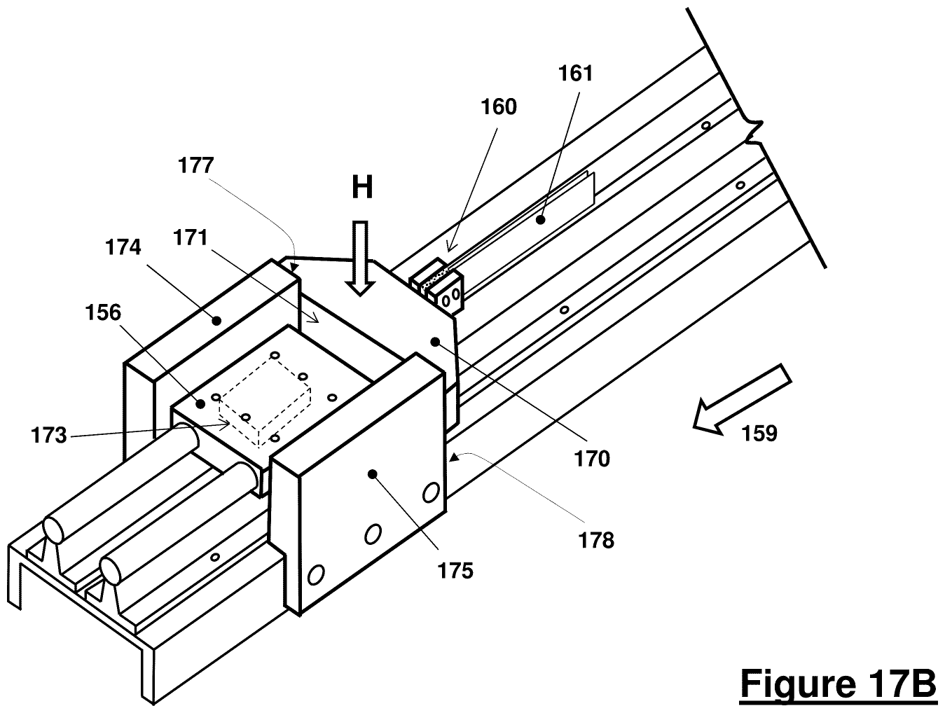

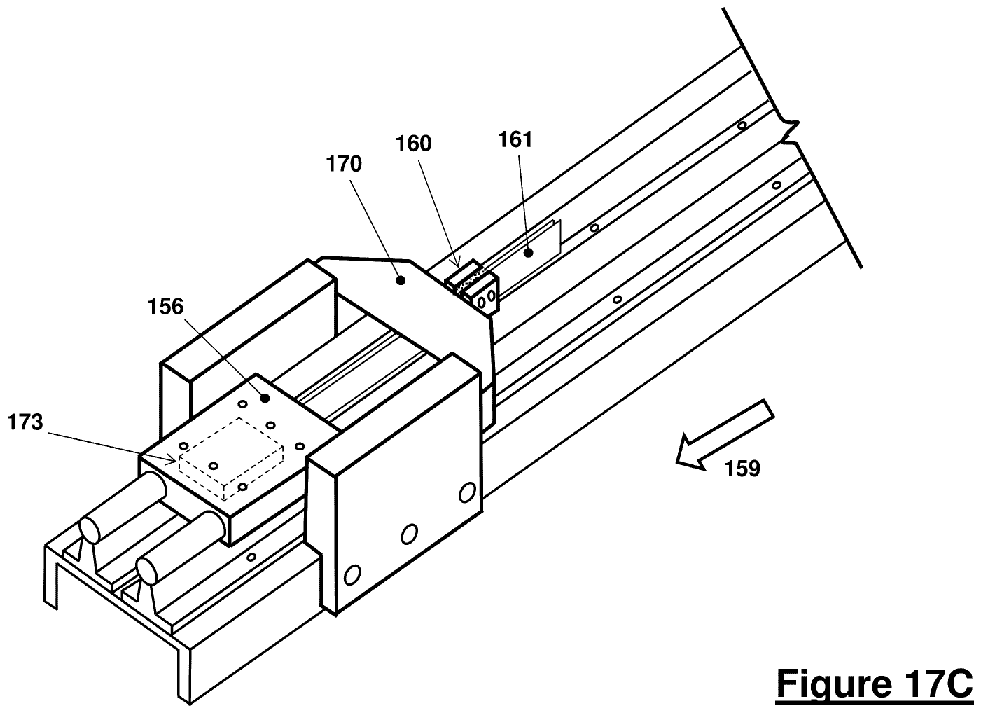

It is, however, appreciated by those skilled in the art that the design of the mechanical shock loading machine embodiment 120 of FIG. 12 only allows for a relatively limited aforementioned impact surface areas between the braking members and the stop elements. This is the case since as can be seen in the schematic of FIG. 12, the stop member has to pass though the grove 122 in the test platform 121 to engage the braking member 126, and that the impacting surface between is desired to be as close to the center of mass of the test platform 121 as possible. In addition, since the relatively small surfaces 125 and 128, FIG. 14, and surface 136a, FIG. 15, and surface 137, FIG. 16, of the braking member are available for engagement with the stop 57, therefore these impacting surfaces cannot be enlarged without lowering the impacting (shock loading applied to the test platform 121) significantly below the center of mass of the test platform and also significantly increasing the mass of the test platform. The following mechanical shock loading machine embodiment 150 shown in FIG. 17A is configured to increase the aforementioned impact surfaces to any desired level to achieve the required smooth deceleration of the machine braking member.

The isometric view of the mechanical shock testing machine embodiment 150 is shown in FIG. 17A. The shock testing machine 150 is horizontally installed so that it can accommodate relatively long rails as described but may also be vertically installed when relatively low acceleration levels and durations are involved. The rails 151 and 152 are attached to the machine base (foundation) structure 153 by rigid support structures 154 and 155, respectively. Machine base structure 153 may be made from relatively heavy structural steel or aluminum and is firmly attached to a concrete slab or the like to withstand the testing shock loading with negligible vibration. Test platform 156 is provided with guides 157 and 158, which may be provided with bearing sleeves (not shown) to freely travel along rails 151 and 152 with minimal friction. It is appreciated that the base structure 153, rails 151 and 152 and their support members 154 and 155 would generally extend past the sectioned end 162 to allow the required distance for the test platform and its accompanying components to be accelerated to the desired velocity as it enters its deceleration section as described later.

During shock loading tests to be described later, test platform 156 is accelerated to a desired velocity from its right-most position in the direction of the arrow 159 as shown in FIG. 17A using the method to be described later in this disclosure. Similar to the embodiment 120 of FIG. 12, a “braking member” 160 (126 in FIG. 12), which is similarly engaged with the braking strip members 161 (46 in FIG. 12). It is also noted that similar to the embodiment 120 of FIG. 12, the provided at least one braking strip member 161 is also fixedly attached to the back of the test platform 156 as, for example, can be seen in the cut-away section of FIG. 4.

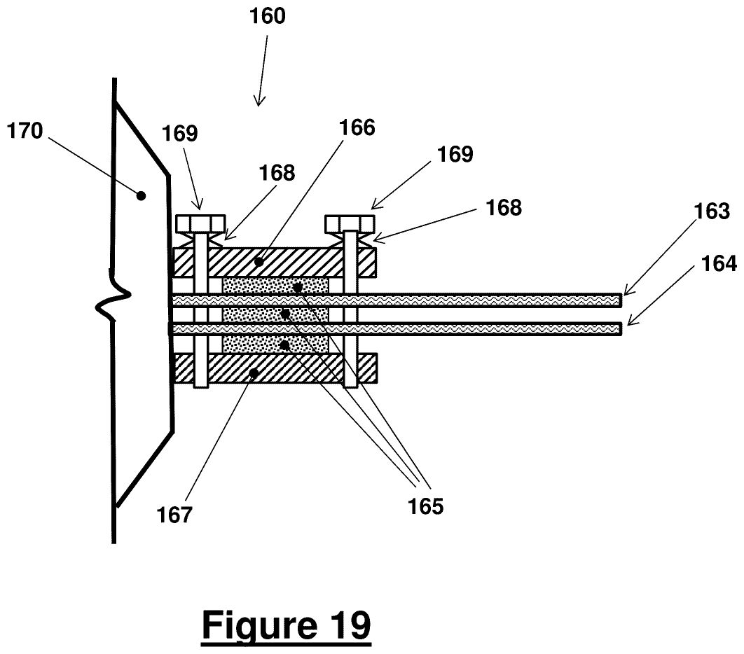

The braking member 160, the top view “G” of it, FIG. 17A, is shown in FIG. 19, is identical to the braking member 126 of FIG. 14, with the exception that it is rotated 90 degrees about the direction parallel to the long axis of the rails 31 and 32. The top view of FIG. 19 shows a typical braking member assembly 160 with two braking strip members 163 and 164 and three brake pads 165. The three brake pads 165 are positioned on the sides and between the two braking strip members 163 and 164, and the assembly is sandwiched between relatively rigid plates 166 and 167, as shown in FIG. 19.

Four pressure adjustment screws 169, FIG. 19, which pass through the holes in the four corners of plate 166 and engage the threaded holes in the bottom plate 167 are provided. In general, relatively stiff springs, such as Bellville washers 168, are provided to assist in the adjustment of the desired pressure over the surfaces of brake pads 163 and 164 to obtain the desired friction force resisting the translation of the brake pads relative to the braking strip members 163 and 164.

It is appreciated that even though only two braking strip members 163 and 164 are shown to be used in the embodiment 150 of FIG. 17A, one or more than two braking strip members and corresponding braking pads may also be used when lower or higher braking forces are desired to be achieved.

As can be seen in the schematic of FIG. 17A, the shock load testing machine embodiment 150 is also provided with the “brake engaging member” 170, which is also provided with guides similar to 157 and 158 of the test platform (not seen in FIG. 17A) to allow it to freely slide over the rails 151 and 152. In the pre-testing state of the shock load testing machine shown in FIG. 17A, the edge 171 of the “brake engaging member” 170 is resting against the surface of the test platform 156, while the plates 166 and 167 braking member 160, FIG. 19, rest against the back surface 172 of the “brake engaging member” as shown in FIGS. 17A and 19.

To perform shock acceleration testing, the component(s) 173 (shown with dashed lines) to be tested is/are fixedly attached to test platform 156, FIG. 17A. The pressure adjustment screws 169, FIG. 19, are then used to adjust the pressure on the brake pads 165 to the level that is needed to achieve the required friction force level on the braking strip members 163 and 164 as the test platform 156 begins to move in the direction of the arrow 159 relative to the braking member assembly 160 after the “brake engaging member” 170 has been stopped by the stop members 174 and 175, FIG. 17A, as described below. The stop members 174 and 175 are fixedly attached to the machine base structure 153 by fasteners and preferably pins 176 and are designed with large enough face surfaces 177 and 178 to accommodate relatively large shock absorbing members as is described later for smooth deceleration of the “brake engaging member” 170 as it is brought to a stop against the stop members 174 and 175.

The test platform 156 and the component being tested 173 are then accelerated in the direction of the arrow 159 to the desired velocity as is described later. Then, as can be seen in the isometric view of FIG. 17B, as the test platform 156 passes between the stop members 174 and 175, at some point, the surface 171 of the “brake engaging member” 170 comes to a stop against the surfaces 177 and 178 of the stop members 174 and 175, respectively. Test platform 156 and the component being tested 173 would then begin to be decelerated, FIG. 17C, until they come to a stop.

It is appreciated that as it was described for the embodiment 120 of FIG. 12, the friction force generated by the braking member assembly 160 would cause the test platform 156 together with the component being tested 173 to be decelerated at a rate inversely proportional to the total mass of the test platform and the component that is being tested. The duration of the applied deceleration to the test platform is determined by the initial velocity of the test platform and the component that is being tested, and is determined as it was previously described for the other embodiments of the present invention when the total kinetic energy of the test platform 156 (neglecting the significantly lighter braking member assembly 160 and the braking strip members 161) and the component that is being tested 173 is equal to the work done by the above friction force of the braking member assembly 160, equations (1)-(4).

It is therefore appreciated by those skilled in the art that the mechanical shock testing machine embodiment 150 of FIG. 17A can therefore increase/decrease the level of test platform 156 deceleration rate by increasing/decreasing the generated friction force of the braking member assembly 160. The user can also increase/decrease the duration of the test platform deceleration by increasing/decreasing the initial velocity of the test platform at the time of “brake engaging member” 170 stopping against the stop members 174 and 175.

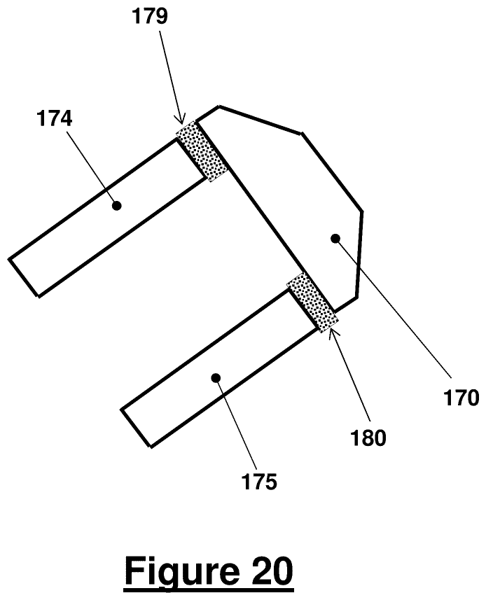

The top view “H” of FIG. 17B, FIG. 20, shows the top surfaces of the “brake engaging member” 170, stop members 174 and 175, and the shock load absorbing elements 179 and 180. The shock/kinetic energy absorbing members 179 and 180 are provided between the “impacting” surfaces of the “brake engaging member” 170 and stop members 174 and 175 to ensure that the “brake engaging member” 170 is decelerated smoothly against the stop members 174 and 175 and would not bounce back against the stops.

It is appreciated by those skilled in the art that as it is a common practice in most machinery with high-speed moving platforms, in all disclosed embodiments of the present invention, commonly used shock absorbers are intended to be used at or close to the end of travel of test platforms, such as test platforms 156 and 121 in the embodiments of FIGS. 17A and 12, respectively, to prevent accidental test platforms reaching and exiting the machine rails.

It is appreciated by those skilled in the art that as it was previously indicated, test platform 156 of the embodiment 150 of FIG. 17A, may be accelerated in the direction of the arrow 159 using different available methods. One common method used in such shock loading machines is the use of gravity and the use of pre-stretched bungees. Current gravity-based shock loading machines cannot provide high shock load (deceleration level) to their test platforms with relatively long durations as was previously indicated. Gravity-based shock loading machines have also been developed that can apply higher shock loading (deceleration level) but still with short durations, usually significantly less than one millisecond.

Pre-stretched bungees have also been used to accelerate test platforms in shock loading machines that are horizontally mounted. It is appreciated that hereinafter, the test platforms are also considered to be carrying the components that are intended to be tested. The methods of employing pre-stretched bungees in shock loading machines to accelerate their test platforms are:
1—A long enough bungee (one or more strands) is attached to the test platform on one end (e.g., 156 in FIG. 17A), and is pulled on the other end (e.g., by a collecting winch) to the desired tensile force, while the test platform is locked in its initial position. The test platform is then released and is accelerated by the force applied by the bungee until the test platform has gained the desired velocity, i.e., kinetic energy, at which point the test platform enters its decelerating phase (e.g., by the stopping of the “brake engaging member” 170 by the stop members 174 and 175) until it comes to a stop. In this method, to achieve high test platform velocity before the start of its deceleration phase, the bungee must start test platform acceleration with a large force and maintain as high a force as possible up to the point of test platform deceleration, noting that high test platform velocity at at start of its deceleration is needed to achieve long duration deceleration (shock loading).
2—A long enough bungee is also attached to the test platform and is similarly used to accelerate the test platform to the desired velocity, at which point the test platform is similarly decelerated to its stop.

The shortcoming of the above first method is that even though high test platform velocities can be achieved over a given test platform length of acceleration distance, but since during the test platform deceleration phase the bungee would still be applying a relatively large force to the test platform, high test platform deceleration rates become difficult to achieve. It is appreciated that for a given maximum initial bungee tension level, the deceleration level can be increased only by allowing the bungee to exhaust its tension at the start of the test platform deceleration phase, thereby lowing the initial test platform velocity at the start of its deceleration phase. In addition, test platform deceleration rate would also decrease and does not stay constant during the deceleration phase.

The shortcoming of the above second method is that for a given test platform length of acceleration distance and initial tension of the provided bungee, significantly lower initial velocity can be achieved at the start of the test platform deceleration phase. This is the case since the bungee tension (pulling force applied to the test platform) is designed to be reduced to zero by the start of the test platform deceleration phase as compared to the aforementioned first method. In addition, there is a practical method of managing the resulting loose bungee(s) as the test platform begins to be decelerated and preventing it from interfering with the motion of the test platform.

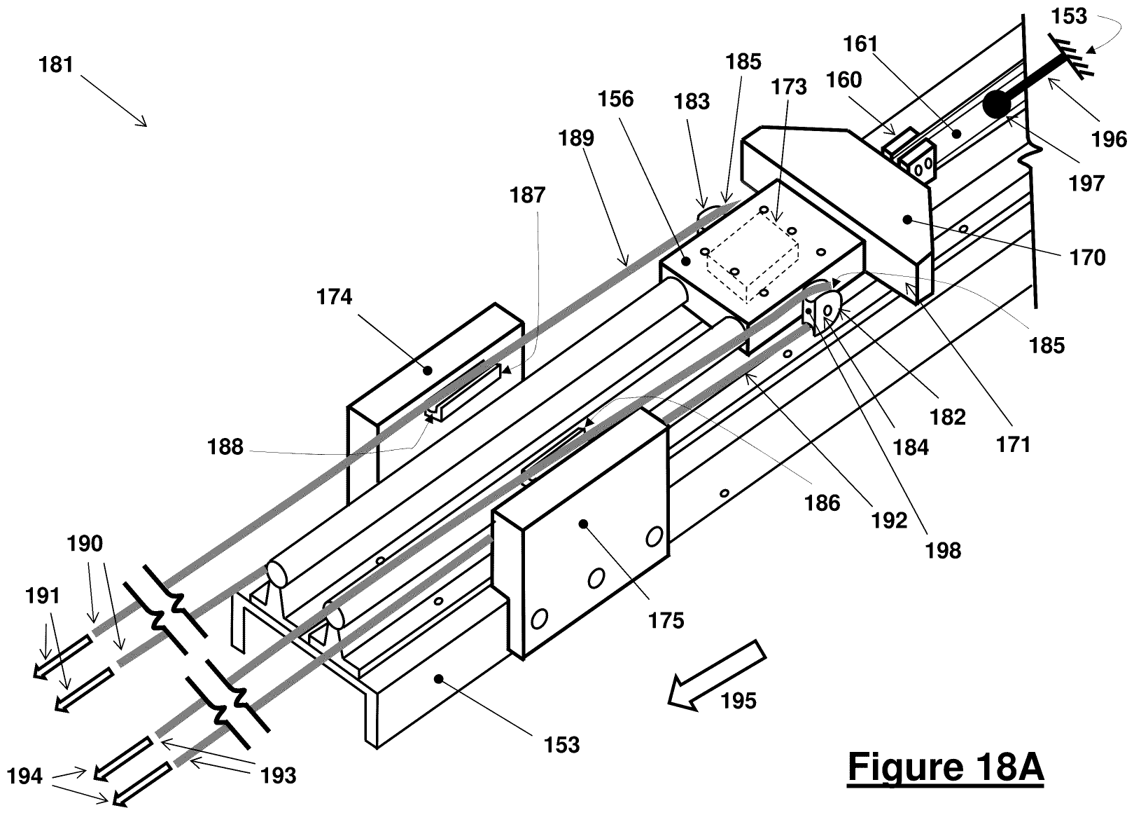

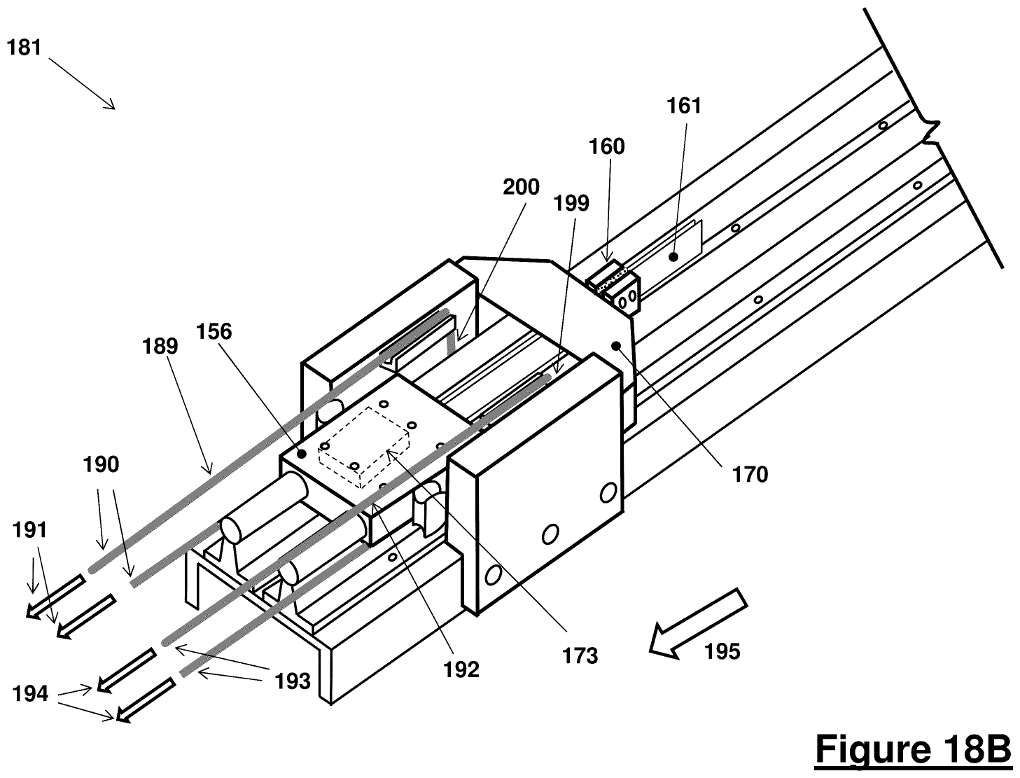

The above shortcomings of the current method of using pre-stretched bungees to accelerate test platforms in shock testing machines and the like are overcome using the novel method described by an example of its application to the shock testing machine embodiment 150 of FIG. 17A as shown in the isometric view of FIG. 18A.

The shock testing machine embodiment 181 of FIG. 18A illustrates the novel method of accelerating the test platform of mechanical shock testing machine embodiment 150 of FIG. 17 by a set of two pre-stretched bungees. The same method may be applied to the test platforms of other disclosed embodiments of the present invention.

All components of the shock testing machine embodiment 181 of FIG. 18A are identical to those of the embodiment 150 of FIG. 17A, except the following added elements and features. A semi-circular member 182 is attached to the side of the test platform 156 by a screw fastener 184 as can be seen in FIG. 18A. The semi-circular member 182 is provided with a circular groove 185 over its circular side, which faces away from the stop 175 in the pre-testing state of the shock testing machine shown in FIG. 18A. An identical semi-circular member 183 is attached and oriented similarly on the opposite side of the test platform as shown in FIG. 18A.

The stop member 174 is provided with the extended member 187, which is provided with a semi-circular channel 188 as shown in FIG. 18A. An identical but “left-handed” extended member 186 is similarly provided on the stop member 175 as can be seen in FIG. 18A. In addition, identical extended members 187 and 186 are provided below each of the two extended members, but with their grooves 188 facing down (cannot be seen in the isometric view of FIG. 18A). The grooves 188 of the indicated lower extended members are spaced relative to the extended members 187 and 186 slightly longer than the diameter of the semi-circular members 183 and 182, respectively.

Before deploying the shock testing machine bungees, the braking strip members 161 is fixedly held against the base structure 153 of the machine by a releasable clamp 197 which is held against the machine base structure 153 (shown as ground in FIG. 18A) via preferably a flexible cable 196 as shown in FIG. 18A.

In the isometric view of FIG. 18A, the shock testing machine embodiment 181 is shown to be provided with two separate bungees 189 and 192. The bungee 192 is seen to pass over the channel 188 of the extended member 186, enter the circular grove 185 of the semi-circular member 182 from the top, wind around the circular groove 185 and extend from the bottom of the semi-circular member 182 out towards its end 193 (lower end). The two ends 193 of the bungee 192 can now be pulled in the direction of the arrows 194 to extend (stretch) the bungee. The other bungee 189 is similarly passed over channel 188 of the extended member 187 from the end 190 (top), wrapped over the semi-circular member 183 in the member groove 185 (not fully visible in FIG. 18A), to the lower end 190. The two ends 190 of the bungee 189 can now be pulled in the direction of the arrows 191 to extend (stretch) the bungee.

It is appreciated that the center of the channel 188 of the extended member 186 is positioned in the plane of the center of the groove 185 of the semi-circular member 182, so that the top and bottom sections of the bungee 192 are centrally positioned in this plane. The same is the case for bungee 189 and groove 185 of the semi-circular member 183 and the channel 188 of the extended member 187.

To perform shock acceleration testing, the component(s) 173 (shown with dashed lines) to be tested is/are fixedly attached to test platform 156, FIG. 18A. The pressure adjustment screws 169, FIG. 19, are then used to adjust the pressure on the brake pads 165 to the level that is needed to achieve the required friction force level on the braking strip members 163 and 164 as the test platform 156 begins to move in the direction of the arrow 195 relative to the braking member assembly 160 after the “brake engaging member” 170 has been stopped by the stop members 174 and 175 as shown in FIG. 17B, as described below. As it was described for the embodiment of FIG. 17A, the stop members 174 and 175 are fixedly attached to the machine base structure 153 by fasteners and preferably pins 176 and are designed with large enough face surfaces 177 and 178 to accommodate relatively large shock absorbing members as is described later for smooth deceleration of the “brake engaging member” 170 as it is brought to a stop against the stop members 174 and 175, hereinafter referred to as the “initial test platform assembly”.

The release clamp 197 is engaged to the braking strip members 161 to prevent the motion of the assembly of braking strip members, braking member assembly 160, “brake engaging member” 170 and the test platform 156. The bungees 189 and 192 are then stretched (tensioned) by the pulling of their free ends 190 and 193 in the direction of the arrows 191 and 194, respectively. It is appreciated that the bungees 189 and 192 are usually much longer than shown in FIG. 18A, and their lengths and their “spring rates” are generally selected such that they can be stretched (tensioned) long enough to apply the desired total force level (hereinafter referred to as the “initial accelerating force”) to the “initial test platform assembly”, while as the bungees 189 and 192 are disengaged from the test platform as described below, the total force that is still being applied to the “initial test platform assembly” is not significantly below the “initial accelerating force”. This is obviously the desired goal to have a large accelerating force to accelerate the “initial test platform assembly” during its entire travel before the braking mechanism would begin to decelerate the test platform as is described below.

Then when the “initial test platform assembly” is released by the release clamp 197, the “initial test platform assembly” is accelerated in the direction of the arrow 195 by the tensioned bungees 189 and 192 to the user set velocity as the test platform 156 passes between the stop members 174 and 175 and the surface 171 of the “brake engaging member” 170 comes to a stop against the surfaces 177 and 178 (FIG. 17A) of the stop members 174 and 175, respectively.

The shock testing machine embodiment 181 of FIG. 18A is designed such that as the test platform 160 enters the space between the stops 174 and 175 and begin to travel between them, as the surface 198 of the semi-circular members 182 and 183 reaches the extended members 186 and 187, the portion of the sections of the bungees 192 and 189, 199 and 200, respectively, which are over the circular grooves 185 of the semi-circular members 182 and 183 would stay at the facing sides of the extended members 186 and 187 and their provided lower members as can be seen in FIG. 18B, thereby disengaging the bungees 192 and 189 from the test platform 156. Test platform 156 and the component being tested 173 would then begin to be decelerated as it was described for the embodiment 150 of FIG. 17A until they come to a stop.

It is appreciated that as it was described for the embodiments 120 and 150 of FIGS. 12 and 17A, respectively, the friction force generated by the braking member assembly 160 would cause the test platform 156 together with the component being tested 173 to be decelerated at a rate inversely proportional to the total mass of the test platform and the component that is being tested. The duration of the applied deceleration to the test platform is determined by the initial velocity of the test platform and the component that is being tested, and is determined as it was previously described for the other embodiments of the present invention when the total kinetic energy of the test platform 156 and the component that is being tested 173 (neglecting the significantly lighter braking member assembly 160 and the braking strip members 161) is equal to the work done by the above friction force of the braking member assembly 160, equations (1)-(4).

It is therefore appreciated by those skilled in the art that the mechanical shock testing machine embodiment 150 of FIG. 17A can therefore increase/decrease the level of test platform 156 deceleration rate by increasing/decreasing the generated friction force of the braking member assembly 160. The user can also increase/decrease the duration of the test platform deceleration by increasing/decreasing the initial velocity of the test platform at the time of “brake engaging member” 170 stopping against the stop members 174 and 175.

It is appreciated that the top view “H” of FIG. 17B, FIG. 20, also illustrate the top surfaces of the “brake engaging member” 170, stop members 174 and 175, and the shock load absorbing elements 179 and 180 for the shock testing machine embodiment 181 of FIG. 18A. Similarly, the shock/kinetic energy absorbing members 179 and 180 are provided between the “impacting” surfaces of the “brake engaging member” 170 and stop members 174 and 175 to ensure that the “brake engaging member” 170 is decelerated smoothly against the stop members 174 and 175 and would not bounce back against the stops.

It is appreciated by those skilled in the art that an advantage of the mechanical shock testing machine embodiment 181 of FIG. 18A over that of the embodiment 150 of FIG. 17A is that it can be used in applications in which either very high deceleration rate or relatively very high deceleration duration is desired to be achieved. This is the case since for a given distance of bungee acceleration, the bungee pulling force (tension) could be made to be high at the point of engagement of the “brake engaging member” 170 with the stop members 174 and 175, without having the bungee force to act against the test platform decelerating friction force.

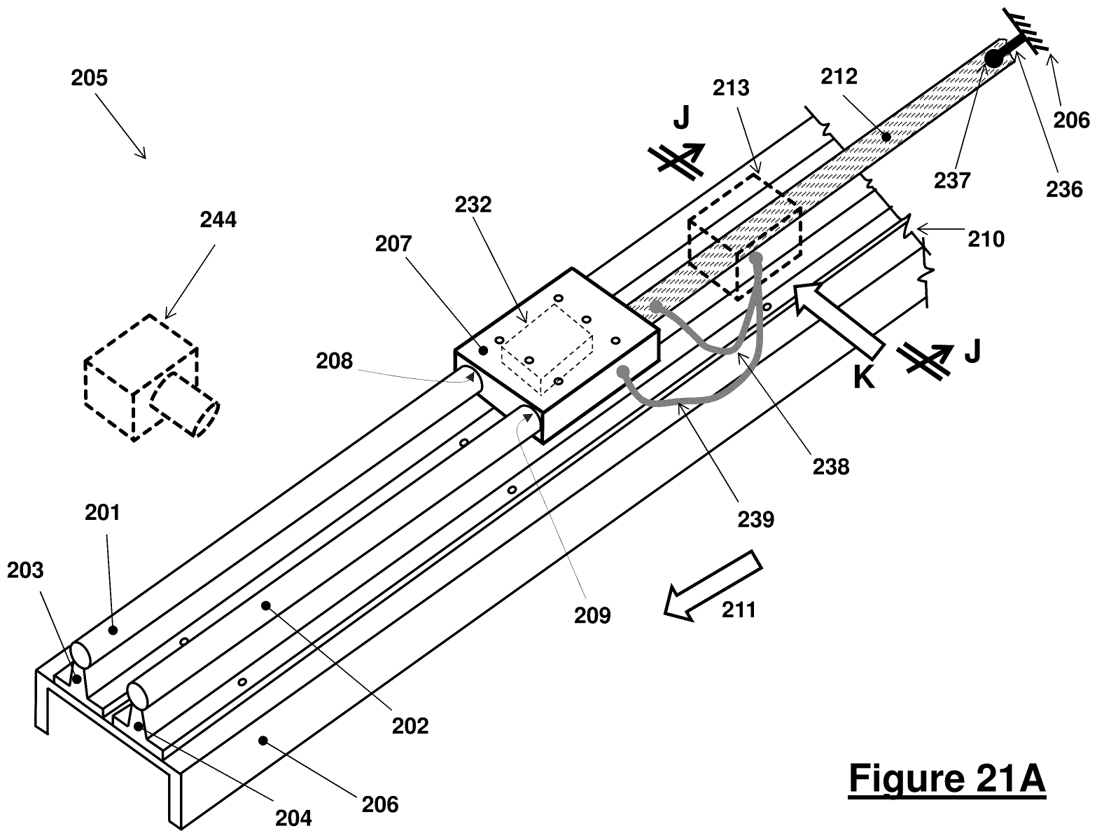

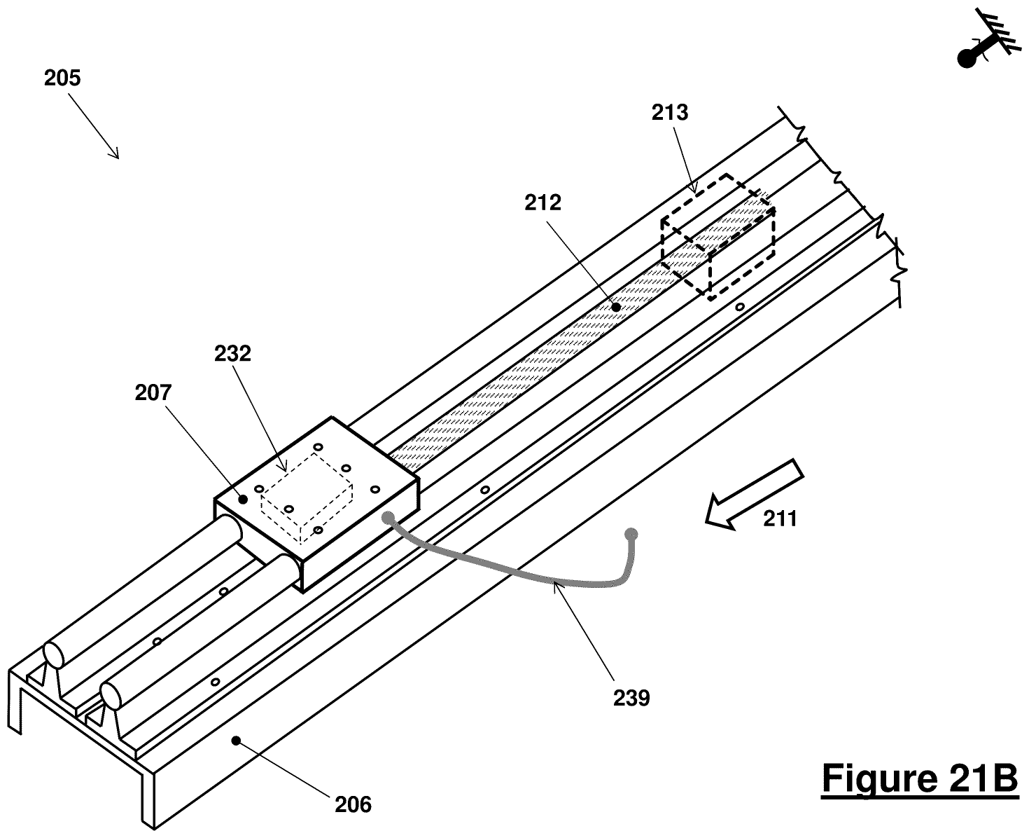

The isometric view of another mechanical shock loading machine embodiment 205 of the present invention is shown in FIG. 21A. The shock testing machine embodiment 150 is horizontally installed so that it can accommodate relatively long rails as it was previously described but may also be vertically installed when relatively low acceleration levels and durations are involved. The rails 201 and 202 are attached to the machine base (foundation) structure 206 by rigid support structures 203 and 204, respectively. Machine base structure 206 may be made from relatively heavy structural steel or aluminum and is firmly attached to a concrete slab or the like to withstand the testing shock loading with negligible vibration. Test platform 207 is provided with guides 208 and 209, which may be provided with bearing sleeves (not shown) to freely travel along rails 201 and 202 with minimal friction. It is appreciated that the base structure 206, rails 201 and 202 and their support members 203 and 204 would generally extend passed the sectioned end 210 to allow the required distance for the test platform and its accompanying components to be accelerated to the desired velocity as it is described later.

During shock loading tests to be described later, test platform 207 is accelerated to the desired velocity from its right-most position in the direction of the arrow 211 as shown in FIG. 17A, preferably using the method to be described for the embodiment 181 of FIG. 18A. Similar to the embodiment 150 of FIG. 17A, the test platform 207 is provided with at least one braking strip member 212, which is also fixedly attached to the back of the test platform 207 by fasteners, for example, similar to as shown in the cut-away section of FIG. 4.

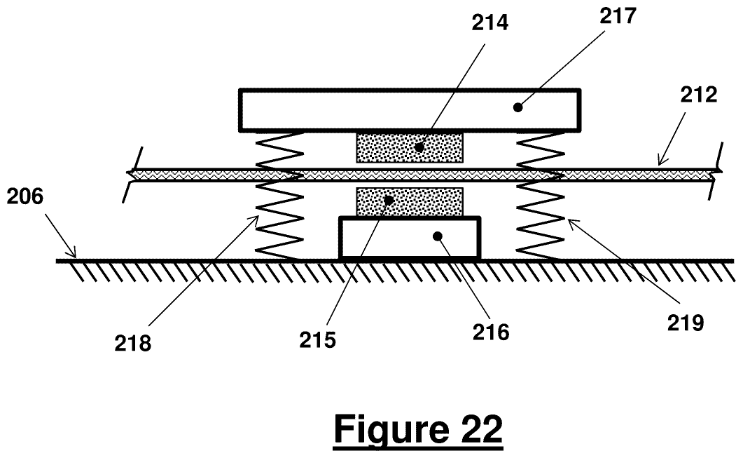

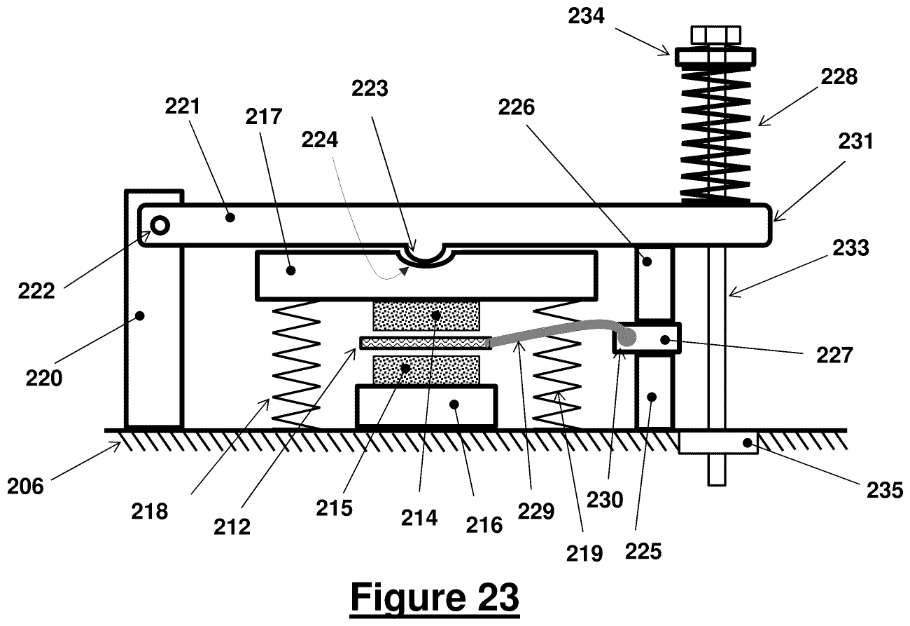

In the mechanical shock loading machine embodiment 205 of FIG. 21A, the braking member assembly 213, shown by dashed lines, is fixedly attached to the base structure 206 of the machine and allows for free passing of the at least one braking strip member 122 before being activated to decelerate the test platform 207 as described later. The view “K”, FIG. 21A, shown in FIG. 22 illustrates the side view of the braking member assembly 213 (without the braking force application mechanism shown in FIG. 23). The cross-sectional view J-J of FIG. 21A shown in FIG. 23 illustrates a typical braking member assembly 213 design with one braking strip members 212 and two brake pads 214, together with an example of a brake activation mechanism that is deployed as described later after the test platform 270 has been accelerated a certain distance in the direction of the arrow 211.

FIG. 22 illustrates the side view “K” of the “braking member assembly” 213 of the mechanical shock testing machine embodiment 205 of FIG. 21A. The braking force application mechanism (shown in FIG. 23) is not shown in this view for the sake of clarity. In this side view of the “braking member assembly”, the side view of the braking strip member 212 is seen to be positioned between two brake pads 214 and 215. It is appreciated that the view “K” of FIG. 22 illustrates the side view of the “braking member assembly” in its pre-braking force application state and small gaps are seen to be provided between the braking strip member 212 and the two brake pads 214 and 215. The brake pad 215 is fixedly attached to the brake pad support member 216, which is in turn fixedly attached to the base structure 206 of the shock testing machine embodiment 205, FIG. 21A. The brake pad 214 is also fixedly attached to its support member 217, which is designed to be larger to provide space for the slightly preloaded pairs of compressive springs 218 and 219, which are provided to prevent the brake pads from engaging the braking strip member 212 by providing the above-mentioned gaps between the brake pads and the braking strip member. The spring pairs 218 and 219 are generally positioned on four corners of the support member 217.

FIG. 22 illustrates the cross-sectional view J-J of the “braking member assembly” of the mechanical shock testing machine embodiment 205 of FIG. 21A. In the cross-sectional view of FIG. 23, the side view of the braking strip member 212 is seen as positioned between the two brake pads 214 and 215, which are fixedly attached to the supports 216 and 217, respectively. In the cross-sectional view of FIG. 23, the braking force mechanism of the “braking member assembly” 213 is seen to consist of link 221, which is attached to the support 220 by the rotary joint 222. Support 220 is fixedly attached to the base structure 206 of the mechanical shock testing machine as can be seen in FIG. 23. Close to its free end 231, link 221 is provided with at least one preloaded compressive spring 228, which is designed to apply a relatively large clockwise torque to link 221. Clockwise rotation of the link 221 is, however, limited by the member 226, which is fixedly attached to the link 221, and the support member 225, which is fixedly attached to the support structure 206 of the mechanical shock testing machine, and the retractable member 227, which is positioned between the members 225 and 226 as can be seen in FIG. 23. In the configuration shown in FIG. 23, the semi-spherical (or cylindrical) shaped extended member of link 223 is seen to be in contact with its mating, slightly larger, semi-spherical recess provided on the top surface of the brake pad support 217. It is appreciated that in this configuration, the slightly preloaded pairs of compressive springs 218 and 219 press the recess 224 against the semi-spherical member of the link 221, thereby providing a small gap between the braking strip member 212 and the brake pads 214 and 215.

The compressive spring 228 is preloaded by the screw 233, which passes through a hole provided in the link 221 and is screwed to the base structure 206 of the mechanical shock loading machine (a threaded section of which is indicated by the numeral 235). A washer 234 is generally provided under the head of the screw 233 for ease of screwing and unscrewing the screw 233 during adjustment of the compressive spring 228 preloading level.

A cable 229 (238 or 239 in FIG. 21A) is also provided that is attached on one end 230 to the retractable member 227 and to either the braking strip member 212 (indicated as cable 238 in FIG. 21A) as shown in FIG. 23, or to the test platform 207 (indicated as cable 239 in FIG. 21A) on the other end and is used to initiate the process of test platform deceleration as described below. During a shock acceleration testing process, as it is described later, as the test platform is accelerated in the direction of the arrow 211, at some point the cable 229 would extend to its full length and pulls on the retractable member 227, pulling it away from between the members 225 and 226, thereby allowing the preloaded compressive spring 228 to rotate the link 221 in the clockwise direction, thereby closing the gaps between the braking strip member 212 and the brake pads 214 and 215 and apply a compressive force to both sides of the braking strip member 212. It is appreciated that the length of the cable 229 is designed to be adjustable since for a given initial positioning of the test platform 207 relative to the “braking member assembly” 213, the length of the cable 229 (238 or 239 in FIG. 21A) determines the velocity of the test platform at the type of the decelerating friction force application to the braking strip member 212.

To perform shock acceleration testing, the component(s) 232 (shown with dashed lines) to be tested are fixedly attached to test platform 207, FIG. 21A. The preloading force of the compressive spring 228 is adjusted such that once the retractable member 227 is pulled from between the members 225 and 226, the required level of pressure is applied between the brake pads 214 and 215 and the braking strip member 212 to achieve the required friction force level as the braking strip member 212 as the test platform 207 begin to move in the direction of the arrow 211 and the braking strip member is pulled and slides between the two brake pads.

It is appreciated by those skilled in the art that as it was previously indicated, test platform 207 of the mechanical shock testing machine embodiment 205 of FIG. 21A may be accelerated in the direction of the arrow 211 using different available methods. One common method used in such shock loading machines is the use of gravity and the use of pre-stretched bungees. Current gravity-based shock loading machines cannot provide high shock load (deceleration level) to their test platforms with relatively long durations as was previously indicated. The previously indicated shortcomings of the current method of using pre-stretched bungees to accelerate test platforms in shock testing machines and the like was shown to be overcome using the novel method described by its application to the shock testing machine embodiment 150 of FIG. 17A, indicated as the embodiment 181 in the isometric view of FIG. 18A. The shock testing machine embodiment 181 of FIG. 18A illustrates the novel method of accelerating the test platform of mechanical shock testing machine embodiment 150 of FIG. 17 by a set of two pre-stretched bungees.

The same method may be employed to accelerate the test platform of the shock testing machine embodiment 205 of FIG. 21A. However, for the sake of clarity, in the isometric view of 21A of the shock testing machine embodiment 181 the bungee cords and their deployment and collection components are not shown.

Since the bungee-based test platform acceleration method of the mechanical shock testing machine embodiment 181 of FIG. 18A is to be used to accelerate the test platform 207, before deploying the bungees as was described for the embodiment of FIGS. 18A and 18B, the at least one braking strip member 212 is similarly fixedly held against the machine base structure 206 (shown as ground in FIG. 21A) by a quick release clamp 237 via preferably a flexible cable 236 as shown in FIG. 21A. Such quick release clamps are well known in the art and usually use a preloaded spring to snap open the clamp “jaws” once the user pulls on a release lever by an attached pulling cable, such as a LiftingSafety's Automatic release Hook-Clamps manufactured by LiftingSafety company.

Following test component 232 mounting on the test platform 207 and adjustment of the preloading level of the compressive spring 228 to the required level to achieve the desired test platform deceleration level, the braking strip member 212 is clamped to the base structure 206 of the shock testing machine as shown in FIG. 21A by the clamp 237 via the cable 236. The release clamp 237 is engaged to the braking strip members 212 to prevent the motion of the assembly of test platform and braking strip members from moving while they are being prepared to be accelerated, for example, by the bungee-base method described for the mechanical shock testing machine embodiment 181 of FIG. 18A. When using the bungee-based method of FIG. 18A, the accelerating bungees are then stretched (tensioned) as was described for the embodiment of FIG. 18A to the required force level. The assembly of braking strip member 212 and test platform 207 is then accelerated in the direction of the arrow 211 by releasing the quick release clamp 237.

It is appreciated that the free length of the cable 238 or 239, which is used to connect the retractable member 227, FIG. 23, to one of the members of the assembly of braking strip member 212 and test platform 207, is selected such that once the accelerating bungees have release the test platform 207 or shortly after, FIG. 18B, the cable 238 or 239 that is used is extended to its full length and pulls out the retractable member 227 from between the members 225 and 226. The preloaded compressive spring 228 would then force the lever 221 to rotate in the clockwise direction to close the gap between the braking strip member 212 and the brake pads 214 and 215, thereby pressing the brake pads on the two surfaces of the braking strip member 212. It is appreciated that the ratio of the distances from the joint 222 to the compressive spring 228 and the extended semi-spherical member 223 of the link 221 would amplify the compressive spring force as it is applied to the brake pads.

It is appreciated that the above test platform 207 acceleration level and the distance that the test platform is set to travel to gain the desired velocity before the retractable member 227 is pulled and the desired decelerating friction force is applied to the braking strip member 212 are all predetermined by the user and set as was previously described for this and other embodiments of the present invention. Thus, following the application of the braking force by the brake pads 214 and 215, the test platform, thereby the component to be tested 232, FIG. 21A, are decelerated at the prescribed level, FIG. 21B, and are brought to a stop over the prescribed duration.

It is also appreciated by those skilled in the art that one of the main advantages of the design embodiment 205 type of mechanical shock testing machines is that since the machine “braking member assembly” 213 is fixedly attached to the machine base structure 206, FIG. 21A, it does not have to be decelerated very rapidly to a stop (as, for example, the “brake engaging member” 170 of the embodiment 181 of FIG. 17B or the braking member 126 of the embodiment 120 of FIG. 12), before a decelerating friction force is applied to the machine test platform (156 and 121 in the embodiments of FIGS. 17B and 12, respectively). As a result, a deceleration shock loading pulse application to the test platform and thereby to the component that is being tested is averted and the test platform and its mounted component that is being tested against deceleration shock loading is decelerated smoothly to a stop.

It is also appreciated by those skilled in the art that another main advantage of the design embodiment 205 type of mechanical shock testing machines is that the user does not have to spend the required and usually relatively long time to select shock load absorbing elements (for example 179 and 180, FIG. 20, in the embodiment 150 of FIG. 17A), usually by a process of trial and error and actual testing on the machine. It is also appreciated that in most cases, the shock load absorbing elements must be removed and replaced after each test, which does also require considerable user time. In comparison, the design embodiment 205 type of mechanical shock testing machines do not require the above shock load absorbing elements, and the user only need to reset the machine to its initial state, i.e., the test platform for the next round of acceleration and deceleration as was described above.

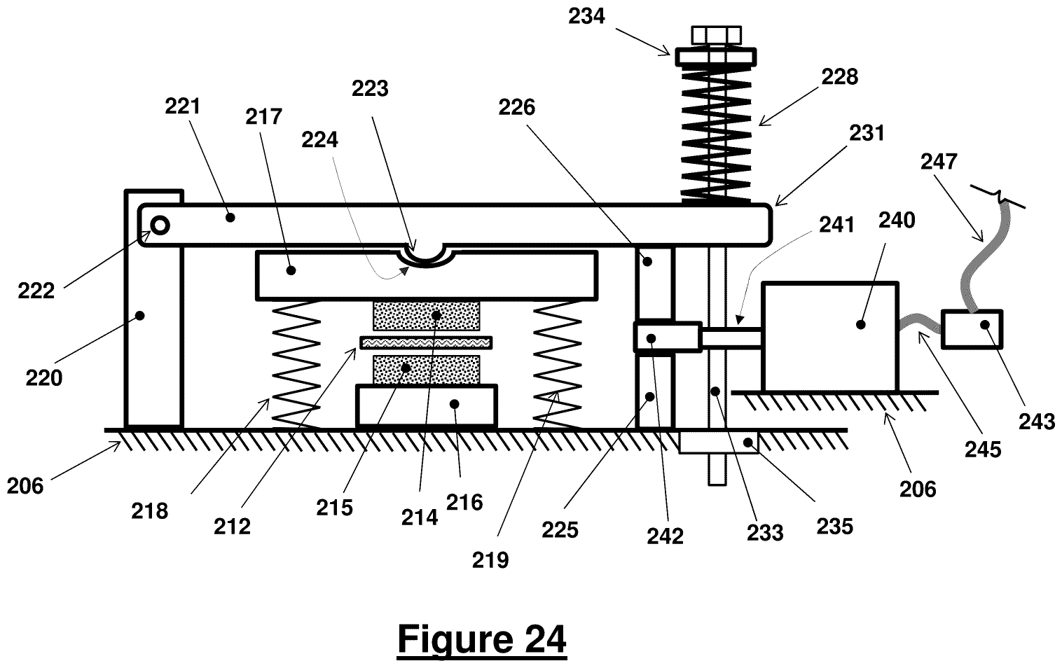

In the mechanical shock testing machine embodiment 205 of FIG. 21A, the brake pad release mechanism used consists of the cable 238 or 239 (229 in FIG. 23) to be pulled as the test platform 207 is accelerated to its prescribed velocity, thereby pulling the retractable member 227 from between the members 225 and 226, thereby allowing the preloaded compressive spring 228 to press the brake pads 214 and 215 against the braking strip member 212. It is appreciated by those skilled in the art that numerous other mechanisms known in the art may also be used to perform the same function of activating the braking mechanism. This includes active, as well as passive mechanisms. An example of a typical powered mechanism that can be employed is shown in the schematic of FIG. 24.

FIG. 24 illustrates the cross-sectional view J-J of the “braking member assembly” of the mechanical shock testing machine embodiment 205 of FIG. 21A with an alternative active means of releasing the braking mechanism replacing the passive cable pulled means shown in the schematic of FIGS. 23 and 21A. In this alternative powered braking release mechanism, all components shown in the schematic 24 are identical to those of the schematic of FIG. 23, except that the cable 229 used for pulling the retractable member 227 from between the members 225 and 226 is replaced by a powered actuator (a pneumatic piston in the case of the schematic of FIG. 24).

As can be seen in the schematic of FIG. 24, the brake mechanism pneumatic linear actuator 240 is fixedly attached to the base structure 206 of the shock testing machine embodiment 205, FIG. 21A. The piston rod 241 of the pneumatic actuator is then fixedly attached to the retractable member 242 (227 in FIG. 23). In general, diaphragm type linear pneumatic actuators are preferred since they pose minimal actuation friction and can therefore actuate faster than piston type pneumatic actuators). The pressurized air is supplied by a line 247 to the pneumatic actuator 240 through a preferably electrically actuated pneumatic valve 243 via line 245.

The mechanical shock testing machine embodiment 205 of FIG. 21A that is provided with the modified braking member assembly of FIG. 24 would also function very similarly. Following test component 213 mounting on the test platform 207 and adjustment of the preloading level of the compressive spring 228 to the required level to achieve the desired test platform deceleration level, the braking strip member 212 is clamped to the base structure 206 of the shock testing machine as shown in FIG. 21A by the clamp 237 via the cable 236. The release clamp 237 is engaged to the braking strip members 212 to prevent the motion of the assembly of test platform and braking strip members from moving while they are being prepared to be accelerated, for example, by the bungee-base method described for the mechanical shock testing machine embodiment 181 of FIG. 18A. When using the bungee-based method of FIG. 18A, the accelerating bungees are then stretched (tensioned) as was described for the embodiment of FIG. 18A to the required force level. The assembly of braking strip member 212 and test platform 207 is then accelerated in the direction of the arrow 211 by releasing the quick release clamp 237.

An optical position sensor 244 shown in dashed lines in FIG. 21A is then positioned such that as the test platform 207 has been accelerated to its required speed, the optical position sensor 244 would detect its position and send a signal to the electrically actuated pneumatic valve 243, and have the pneumatic actuator 240 to actuate, i.e., pull its actuating rod 241 back quickly and pull out the retractable member 242 from between the members 225 and 226 (electrical wiring not shown). It is appreciated optical position sensors are well known in the art and are readily set up to perform the indicated task. It is also appreciated that other types of position sensors well known in the art, such as electrical or pneumatic micro-switches with proper pneumatic valves may also be used for the above purpose.

The preloaded compressive spring 228 would then force the lever 221 to rotate in the clockwise direction to close the gap between the braking strip member 212 and the brake pads 214 and 215, thereby pressing the brake pads on the two surfaces of the braking strip member 212. The ratio of the distances from joint 222 to the compressive spring 228 and the extended semi-spherical member 223 of the link 221 would amplify the compressive spring force as it is applied to the brake pads.

It is appreciated that the above test platform 207 acceleration level and the distance that the test platform is set to travel to gain the desired velocity before the retractable member 242 is pulled and the desired decelerating friction force is applied to the braking strip member 212 are all predetermined by the user and set as was previously described for this and other embodiments of the present invention. Thus, following the application of the braking force by the brake pads 214 and 215, the test platform, thereby the component to be tested 232, FIG. 21A, are decelerated at the prescribed level, FIG. 21B, and are brought to a stop over the prescribed duration.

It is appreciated that the mechanical shock testing machine embodiment 205 of FIG. 21A with the modified braking member assembly of FIG. 24 would still provide the advantages of the shock testing machine with the braking member assembly of FIG. 23, i.e., the test platform 207 and its mounted component 232 that is being tested against deceleration shock loading is decelerated smoothly to a stop.

Similarly, mechanical shock testing machine embodiment 205 of FIG. 21A with the modified braking member assembly of FIG. 24 would also retain the advantage of its design in that the user does not have to spend a relatively long time to select shock load absorbing elements (for example 179 and 180, FIG. 20, in the embodiment 150 of FIG. 17A), usually by a process of trial and error and actual testing on the machine. It is also appreciated that in most cases, the shock load absorbing elements must be removed and replaced after each test, which does also require considerable user time. In comparison, the design embodiment 205 type of mechanical shock testing machines do not require the above shock load absorbing elements, and the user only need to reset the machine to its initial state, i.e., the test platform for the next round of acceleration and deceleration as was described above.

It is appreciated that in all the above disclosed embodiments of the present invention, the generated friction force between braking strips and brake pads is used to decelerate the test platform of the mechanical shock testing machines. For this reason, before performing and shock testing, the user must adjust the friction force that the would be provided by the braking force generating members, for example, the braking member assembly 126 of the embodiment 120 of FIG. 12, the braking member 160 of the embodiment 150 of FIG. 17A, and the braking member assembly 213 of the 205 of FIG. 21A. The generated friction forces is obviously a function of the brake pad characteristics, the forces applied by the brake pads to the braking strips and to a lesser degree the surface conditions and contact areas. The user may estimate the friction forces that could be generated, particularly after a few tests, but to arrive at the required friction forces for a prescribed deceleration rate and duration, the user has to be able to rapidly measure the actual friction force before starting to test one or a set of test objects, and usually after each few tests to ensure that the specified friction force and thereby the deceleration rate can be achieved. For this reason, it is highly desirable that the friction forces can be readily measurable before each test and used to adjust the level of force that needs to be applied to the brake pads to obtain the required friction force levels.

In general, it is best to make a direct measurement of the friction force in each of the disclosed embodiments of the present invention. This can be done by applying to displace the test platform away from the braking force generating member, i.e., to cause the brake pads to slip over the braking strip surfaces. However, depending on the design of the mechanical shock testing embodiment, different mechanisms and fixtures are generally required to enable the user to force the said test platform displacement away from the brake force generating member. As an example, the method and the mechanisms to achieve this task and measure friction force are described below for the embodiments 120, 150 and 205 of FIGS. 12, 17A and 21A.

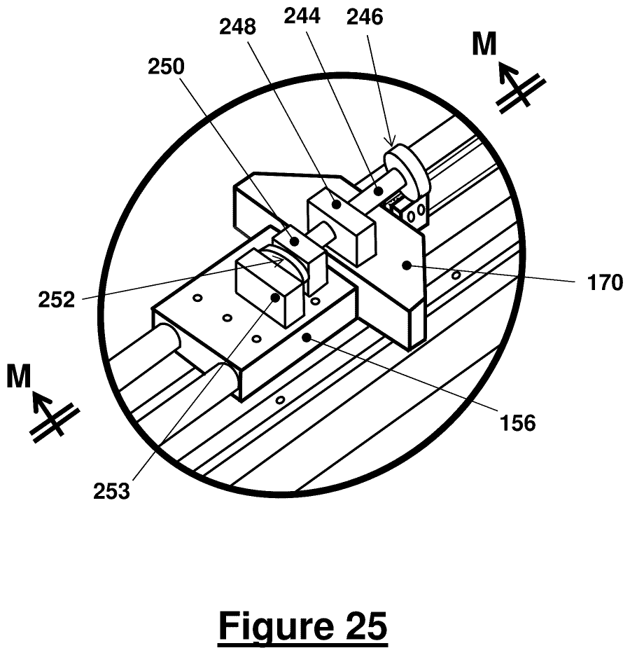

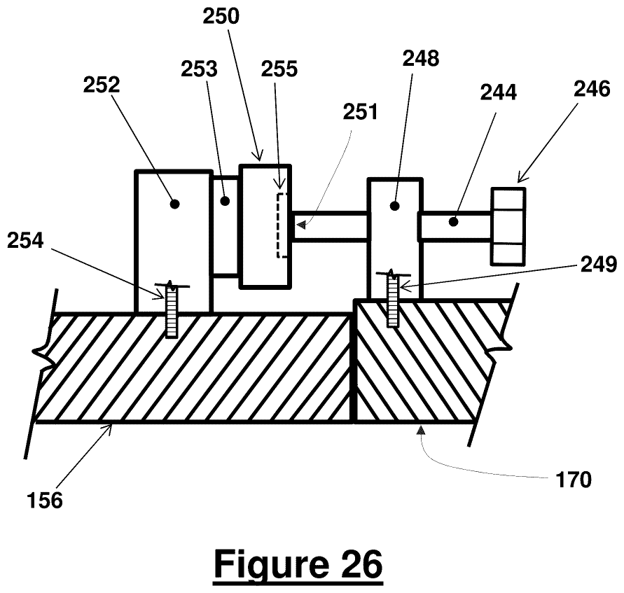

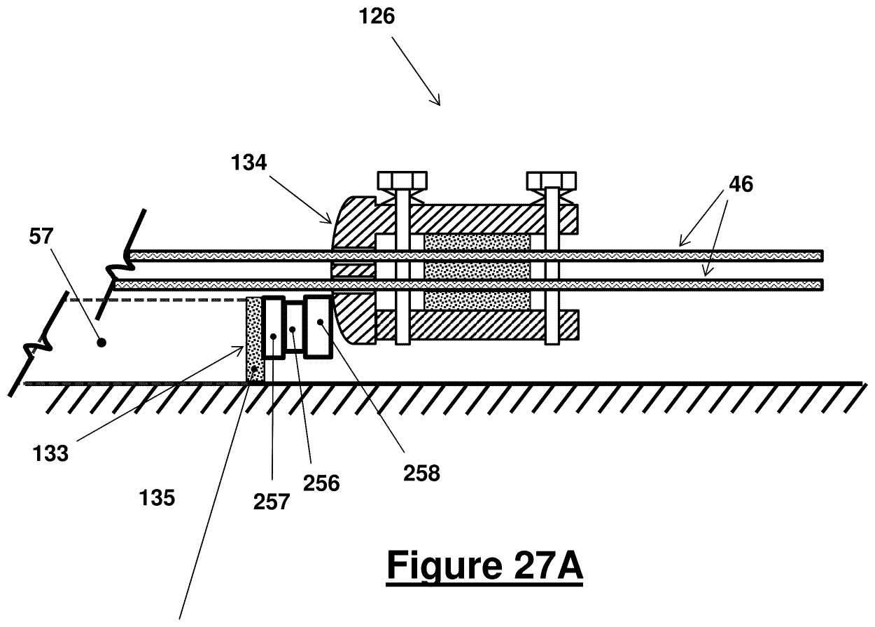

FIG. 25 illustrates the isometric view of the friction force measuring attachment design as employed to the mechanical shock testing machine embodiment 150 of FIG. 17A. The cross-sectional view M-M of the friction force measuring attachment is shown in FIG. 26.

As can be seen in FIGS. 25 and 26, the friction force measuring attachment device consists of a rigid block member 248, which is fixedly attached to the “brake engaging member” 170, FIG. 17A, by screws 249, FIG. 26. A fine threaded “force application screw” 244 is passed through the provided threaded hole in the rigid block member 248 as can be seen in FIGS. 25 and 26.

A similar rigid block member 252, which is fixedly attached to the test platform 156, FIG. 17A, by screws 254, FIG. 26, is provided. A compressive force measuring sensor 253 is then fixedly attached to the rigid block member 252 on one side and to a “force transmission block” 250 on the other side as can be seen in FIGS. 25 and 26. The force gage 253, which is used to measure compressive forces, is well known in the art, such as the “Miniature Button Compression Load Cell with Through Holes” from Omega Engineering Inc. of Norwalk, Connecticut. It is appreciated that the main purpose of the “force transmission block” 250 is to distribute the relatively localized force by the screw 244 over the surface of the compressive force measuring sensor 253.

It is appreciated that in FIG. 26 only a portion of the screws 249 and 254 are only shown, while the screws are intended to pass through holes in the blocks 248 and 252, respectively, and be tightened by their corresponding heads from the top of the said blocks. It is also appreciated that in general, it is highly advisable to provide at least one and preferably two positioning pins between the rigid blocks 248 and 252 and the “brake engaging member” 170 and the test platform 156, respectively to minimize reliance on transfer of force by friction between the attached members.

To measure friction force of the “braking member” 160 of the mechanical shock testing machine embodiment 150 of FIG. 17A, the test components 173 are mounted on the test platform 156 and the machine components are positions as shown in FIG. 17A. Pressure is then applied to the brake pads 165 and the braking strip members 163 and 164 by tightening the sets of screws 160. In general, the user would tighten the screws 169 to a level above what would generate the desired friction force from past experiences. The “force application screw” 244 is then turned via its head 246 to close the gap between the block member 248 and the “force transmission block” 250 and then turned very slowly until the friction force being measured by the compressive force measuring sensor 253 reaches its prescribed level calculated based on the desired test platform deceleration rate, knowing the combined mass of the test platform and the component being tested. Then the user would slowly reduce the force between the brake pads 165 and the braking strip members 163 and 164 by slightly loosening the sets of screws 160 until the friction force measured by the compressive force measuring sensor 253 begins to drop, which indicates that the brake pads have begun slipping over the braking strip members, which indicates that the desired friction force level has been reached. It is, however, appreciated that the friction force might slightly drop once the brake pads begin to slide over the braking strip members, for which the user may have to slightly adjust the pressure between the brake pads and the braking strip members.

It is also appreciated by those skilled in the art, that to ensure smooth motion (rotation) of the contact between the end surface 251 and the surface of the 250 “force transmission block” 250, the contacting surfaces must smooth, have high hardness and slightly lubricated. When the friction force is relatively high, a thrust bearing 255 or a ball or removable swivel end or the like commonly used in such applications may be utilized.

It is also appreciated by those skilled in the art that the same method and mechanism used to measure friction force in the mechanical shock testing machine embodiment of FIG. 17A and illustrated in FIGS. 25 and 26 and described above can be used to measure friction force and similarly adjust the friction force to the desired level to achieve a prescribed test platform deceleration level for shock testing of an object for the mechanical shock testing machine embodiment 205 of FIG. 21A. To this end, using the same components of the friction force measurement and adjustment shown in FIGS. 25 and 26, the rigid block 248, FIGS. 25 and 26, is similarly fixedly attached to the braking member assembly 213, FIG. 21A, and the rigid block 252 is similarly fixedly attached to the test platform 207, FIG. 21A. The friction force would then be measured and adjusted to the required level as was previously described for the mechanical shock testing machine embodiment 150 of FIG. 17A.

It is also appreciated by those skilled in the art that the same method and mechanism used to measure friction force in the mechanical shock testing machine embodiment of FIG. 17A and illustrated in FIGS. 25 and 26 and described above can be used to measure friction force and similarly adjust the friction force to the desired level to achieve a prescribed test platform deceleration level for shock testing of an object for the mechanical shock testing machine embodiment 30 of FIG. 2A. To this end, using the same components of the friction force measurement and adjustment shown in FIGS. 25 and 26, the rigid block 248, FIGS. 25 and 26, is similarly fixedly attached to the carriage member 36, FIG. 2A, and the rigid block 252 is similarly fixedly attached to the test platform 41, FIG. 2A. The friction force would then be measured and adjusted to the required level as was previously described for the mechanical shock testing machine embodiment 150 of FIG. 17A.

It is also appreciated by those skilled in the art that the same method and mechanism used to measure friction force in the mechanical shock testing machine embodiment of FIG. 17A and illustrated in FIGS. 25 and 26 and described above can be used to measure friction force and similarly adjust the friction force to the desired level to achieve a prescribed test platform deceleration level for shock testing of an object for the mechanical shock testing machine embodiment 60 of FIG. 6. To this end, using the same components of the friction force measurement and adjustment shown in FIGS. 25 and 26, the rigid block 248, FIGS. 25 and 26, is similarly fixedly attached to the carriage member 136, FIG. 6, and the rigid block 252 is similarly fixedly attached to the test platform 62, FIG. 6. The friction force would then be measured and adjusted to the required level as was previously described for the mechanical shock testing machine embodiment 150 of FIG. 17A.

It is also appreciated by those skilled in the art that the same method and mechanism used to measure friction force in the mechanical shock testing machine embodiment of FIG. 17A and illustrated in FIGS. 25 and 26 and described above can be used to measure friction force and similarly adjust the friction force to the desired level to achieve a prescribed test platform deceleration level for shock testing of an object for the mechanical shock testing machine embodiments 80 and 85 of FIGS. 7 and 8, respectively.

It is appreciated that for mechanical shock testing machines of the type of the embodiment 120 of FIG. 12, since the braking member 126 is already engaged with the braking strip member 46 and moves together with the test platform 121, then the method described for friction force measurement for the above embodiments as shown in FIGS. 25 and 26 cannot be used for the embodiment 120 of FIG. 12. The following two methods may, however, be used to readily measure and adjust the friction force in the mechanical shock testing machines of this type as described below.

In the first method, the braking member 126 is attached to the braking strip member 46 so that test platform can be moved in the direction of the arrow 124 far enough to expose the stop member 57 to the braking member 126 side of the test platform as seen in the configuration of FIG. 15 or 16 depending on the design of these components of the shock testing machine. A compressive force measuring sensor, such as the sensor 253 in FIGS. 25 and 26), is then used to measure the friction force as described below.

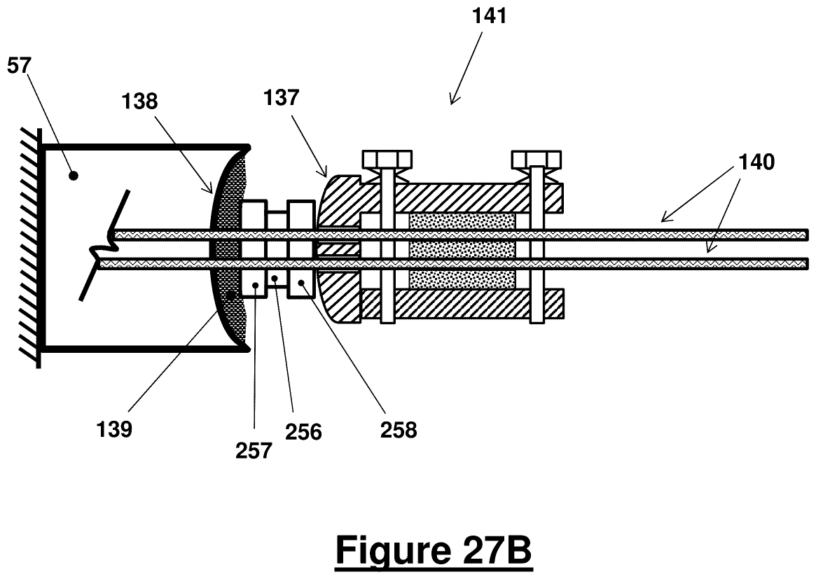

FIGS. 27A and 27B show the braking members 126 and 141, FIGS. 15 and 16, respectively, and the test platform 57 portions of the views of FIGS. 15 and 16 with the inserted compressive force measuring sensor 256 and its force distribution members. In both cases, a compressive force measuring sensor 256, fixedly attached to two relatively rigid frontal and back plates 257 and 258, are used as described below for measuring the generated friction force as the test platforms 121, FIG. 12, is in the process of being decelerated. The function of the two plates 257 and 258 is to distribute the force that is applied to the compressive force measuring sensor 256 and prevent localized force application to the sensor and its damage.

To measure friction force of the “braking member” 126 of the mechanical shock testing machine embodiment 150 of FIG. 17A, the test components 123 are mounted on the test platform 121 and the machine components are positions as shown in FIG. 12, noting that the braking member 126 is already engaged with the braking strip member 46 and moves together with the test platform 121. At this point, from past experiences, initial estimated required pressure, calculated based on the desired test platform deceleration rate and knowing the combined mass of the test platform and the component being tested, is applied to the brake pads 127 and the strip member 46, FIGS. 14 and 15, by tightening the sets of screws 129.

In general, the user would tighten the screws 129 to a level above what is expected to generate the desired friction force from past experiences. The user would then move the test platform in the direction of the arrow 124 until the braking member has reached close to the stop member 57, FIG. 12, to position the assembly of the compressive force measuring sensor 256 and its frontal and back plates 257 and 258 between them as shown in FIGS. 27A and 27B. The user would then mount the bungees (189 and 192, FIG. 18A) used to accelerate the test platform to the test platform as shown in FIG. 18A and begin to slowly apply increasing tension to bungee, while noting the force being measured by the compressive force measuring sensor 256. It is appreciated that the indicated force by the compressive force measuring sensor 256 indicates the resisting friction force between the brake pads 127 and the strip member 46, FIGS. 14 and 15. Then when the required friction force level that is required to achieve the desired test platform deceleration level has been reached, the user would slowly reduce the force between the brake pads 127 and the braking strip members 46 by slightly loosening the sets of screws 129 until the braking strip member 46 begins to slide between the brake pads 127. In general, and for safety reasons, a stop member (not shown) is attached to the base structure 33 of the mechanical shock testing machine to limit the displacement of the test platform 121 to a few millimeters upon the start of the braking strip members 46 slide between the brake pads 127.

The second method is similar to the above first method, but instead of using the compressive force measuring sensor 256 and its frontal and back plates 257 and 258, the friction force is measured by direct measurement of the force applied by the bungees (189 and 192, FIG. 18A). In this method, the user would still move the test platform 121 in the direction of the arrow 124 until the braking member reaches the stop member 57, FIG. 12. The user would then mount the bungees (189 and 192, FIG. 18A) used to accelerate the test platform to test platform 121 as shown in FIG. 18A and begin to slowly apply increasing tension to bungees.

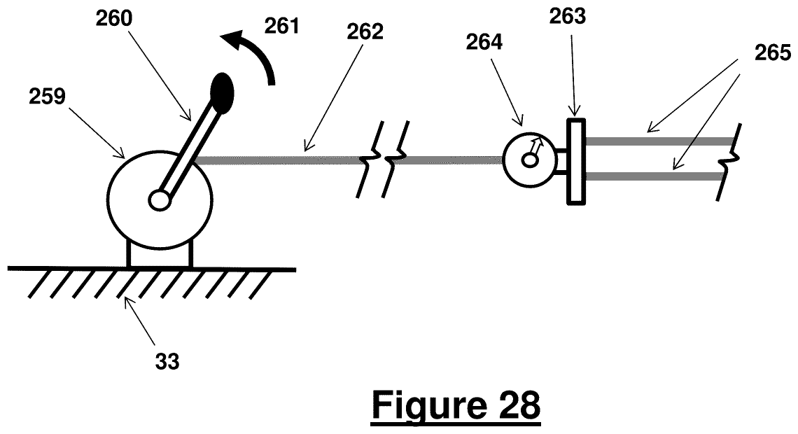

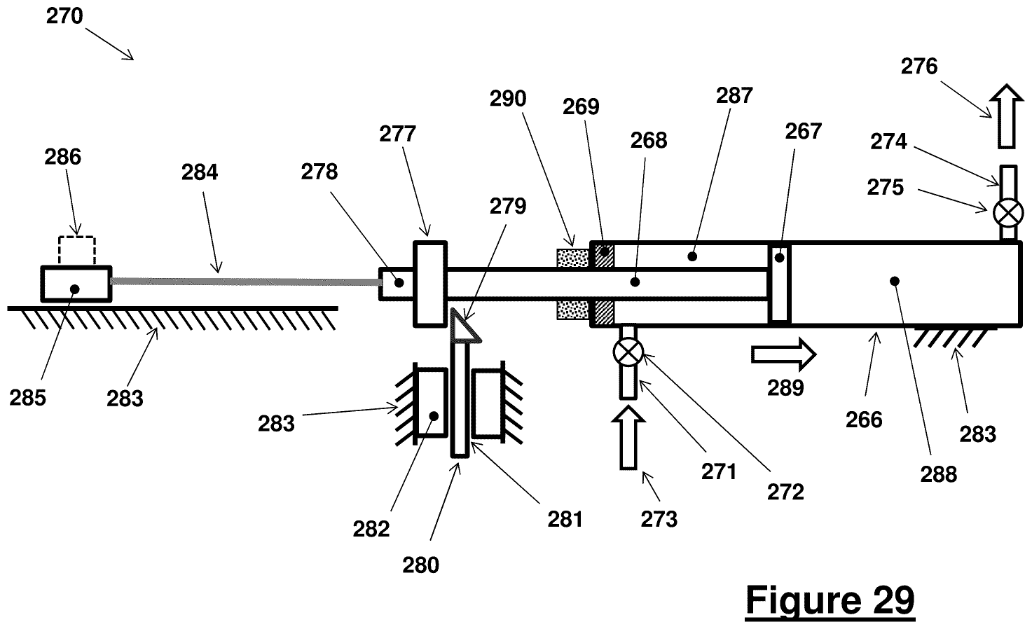

In this method, the bungees 265 (189 and 192, FIG. 18A) are attached to an intermediate rigid member 263, FIG. 28, which is provided to a force sensor 264. The force gage is attached to the rigid member 263 on one end and to a cable 262 on the other end. Cable 262 is then pulled to stretch the bungees 265 by winch 259, which is fixedly attached to the base structure 33 of the mechanical shock testing machine embodiment 120 of FIG. 12. As shown in FIG. 28, winch 259 collects cable 262, i.e., stretches the bungees 265, by the counterclockwise rotation of its handle as shown by the arrow 261. The user would then stretch the bungees 265 while noting the force measured by the force sensor 264, which indicates the resisting friction force between the braking strip members 46 and the brake pads 127, FIG. 14, of the mechanical shock testing machine embodiment 120 of FIG. 12.

Then when the required friction force level that is required to achieve the desired test platform deceleration level has been reached, the user would slowly reduce the force between the brake pads 127 and the braking strip members 46 by slightly loosening the sets of screws 129 until the braking strip member 46 begins to slide between the brake pads 127, FIG. 14. In general, and for safety reasons, a stop member (not shown) is attached to the base structure 33 of the mechanical shock testing machine to limit the displacement of the test platform 121 to a few millimeters upon the start of the braking strip members 46 slide between the brake pads 127.

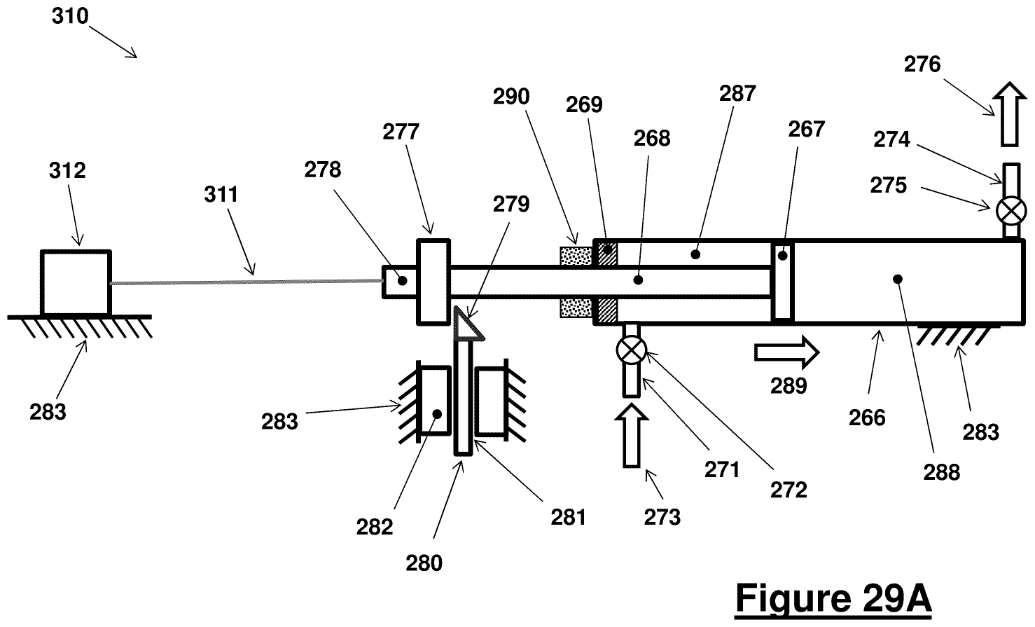

FIG. 29 illustrates the schematic of the pneumatic acceleration shock testing machine embodiment 270 of the present invention. The pneumatic acceleration shock testing machine embodiment 270 is seen to consist of a pneumatic cylinder 266, within which the piston 267 is free to displace and thereby translate the piston rod 268. Piston 267 is provided with customarily used seals (not shown) and the piston rod is provided with seals 269 to minimize any gas leakage as is well known in the art. The pneumatic cylinder 266 is fixedly attached to the base structure 283 of the pneumatic acceleration shock testing machine. In the schematic of FIG. 29, an inlet pipe 271 with the open/close valve 272 is provided to the cylinder 266 on the piston rod 268 side of the cylinder for primarily letting air/gas in as indicated by the arrow 273 when the valve 272 is in its open state. Similarly, an outlet pipe 274 with the open/close valve 275 is provided to the cylinder 266 on the opposite side of the cylinder 266 for primarily letting air/gas out as indicated by the arrow 276 when the valve 275 is in its open state.

As can be seen in the schematic of FIG. 29, a stop member 277 is fixedly attached to the free end 278 of the piston rod 268. In the configuration of the pneumatic acceleration shock testing machine embodiment 270, the tip 279 of a sliding member 280 is in engagement with the stop member 277, preventing the piston rod 268 from displacing to the right as viewed in FIG. 29. The sliding member 280 is free to slide in the guide 281, which is provided in the member 282, which is fixedly attached to the base structure 283 of the pneumatic acceleration shock testing machine. The pneumatic acceleration shock testing machine is also provided with an attachment member 284, which is fixedly attached to the tip 278 of the piston rod 268 on one end and to the test platform 285 on the other end. The attachment member 284 may be a relatively rigid bar, but as it is described below, it is preferably a cable, such a well-known airplane cable. The test platform is provided with attachment points such tapped holes and guides for fixedly attaching the object(s) to be tested under acceleration shock loading. The test platform is also preferably provided with a guide, such as those shown in FIG. 17A for the test platform 156, to ensure a controlled motion during acceleration shock testing.

To perform an acceleration shock testing, the component(s) to be tested 286 (shown with dashed lines) are fixedly attached to test platform 285, FIG. 29. The valve 275 is opened. The valve 272 is then opened to allow pressurized gas to flow into the pneumatic cylinder compartment 287 through the pipe 271 as shown by the arrow 273. It is appreciated that the pressurized compartment 287 and the ambient pressure in the aft compartment 288 of the pneumatic cylinder generates a differential pressure that would tend to accelerate the piston 267 to the right in the direction of the arrow 289. However, in the configuration of FIG. 29, the tip 279 of the sliding member 280, which is in engagement with the stop member 277 of the piston rod 268 prevents rightward motion of the piston 267 and piston rod 268 assembly.

Then to subject the component(s) 286 to an acceleration shock test, the sliding member 280 is pulled back from its tip 279 engagement with the stop member 277, thereby suddenly releasing the piston rod 268. The differential pressure between the chambers 287 and 288 would then apply a force over the area of the piston 267, which would accelerate the piston rod 268 and thereby the test platform 285 via the cable 284 and the components 286 that are being tested in the direction of the arrow 289, FIG. 29.

It is appreciated that as the piston 267 is accelerated and travels to the right in the in the direction of the arrow 289, FIG. 29, the air (gas) contained in compartment 288 of the pneumatic cylinder 266 is exhausted through the outlet pipe 274 and through the open valve 275. The opening of the valve 275 may therefore be used to control the rate of air discharge from the compartment 288 of the pneumatic cylinder 266, thereby adjust the acceleration and maximum velocity of the piston 267 and thereby the test platform 285.

It is also appreciated that to maximize the acceleration level of the piston 267 and thereby to connecting test platform 285, FIG. 29, the exhaust vale 275 and the exhaust pipe 274 must have relatively large openings to minimize their resistance to the outflow of the air (gas) contained in the compartment 288 of the pneumatic cylinder 266.

It is also appreciated that acceleration level of the piston 267 and thereby to connecting test platform 285, FIG. 29, can be further increased by using a vacuum pump to vacuum the compartment 288 of the pneumatic cylinder 266 before starting the acceleration shock testing, i.e., before disengaging the tip 279 of the sliding member 280 from the stop member 277. In general, the exhaust pipe 274 is preferably attached to a vacuum pump via a vacuum tank, so that the usually remained air (gas) in the compartment 288 would not cause an increase in the compartment pressure as the piston 267 moves close to the end of the pneumatic cylinder.

It is appreciated by those skilled in the art that if the differential air (gas) pressure between the compartments 287 and 288 of the pneumatic cylinder 266 is ΔP, and the exposed area of the piston 267 on the compartment 287 of the pneumatic cylinder, i.e., the surface area of the piston 267 minus the cross-sectional area of the piston rod 268, is A, then the net force F acting on the piston 267 and piston rod 268 assembly (neglecting the relatively small friction forces between the piston seals and internal surface of the piston cylinder and the seals 269 and the piston rod) would be

$$F = Δ PA \qquad ( 5 )$$

And if the total mass of the piston 267, piston rod 268, stop member 277, cable 284, test platform 285, and the component(s) being tested 286 is m, then the test platform 285 and thereby the component(s) being tested 286 are going to be subjected to an acceleration a, given as

$$a = \frac{F}{m} \qquad ( 6 )$$

As an example, in an acceleration shock loading machine that is fabricated by a 3 feet long pneumatic cylinder with an inside diameter of 3 inches and a 0.75 inch diameter piston rod (268 in FIG. 29), the exposed area of the piston 267 on the compartment 287 side of the pneumatic cylinder 266, i.e., the surface area of the piston 267 minus the cross-sectional area of the piston rod 268,

$$A = \frac{π}{4} [ {3}^{2} - {0.75}^{2} ] = 6.63 {in}^{2}$$

Then for an inlet air pressure of 120 psi used to fill the compartment 287 and considering an atmospheric pressure of 14.7 psi in the chamber 288 of the pneumatic cylinder 266, the differential pressure ΔP is calculated to be

$$Δ P = 120 - 14.7 = 105.3 psi$$

The force F is then calculated from equation (5) as

$$F = Δ PA = 105.3 \times 6.63 = 698 lbf = 3106 N$$

For an acceleration shock testing machine with the above dimensions that is fabricated and tested at Omnitek Partners, LLC, and tested, the total mass m of the piston 267, piston rod 268, stop member 277, cable 284, and test platform 285 was measured to be around 1.2 Kg, thereby neglecting the relatively small aforementioned friction forces, the resulting test platform acceleration is determined from equation (6) to become

$$a = \frac{F}{m} = \frac{3106}{1.2} = 2588 m / {s}^{2} = 264 G$$

It is appreciated that as the piston 267 and piston rod 268 is being accelerated in the direction of the arrow 289 following the release of the stop member 277, the pressure in the compartment 287 is desired to be maintained or drop relatively small amount so that the acceleration of the piston and piston rod assembly and thereby the test platform 285 to be maintained. This is usually achieved by connecting the chamber 287 to a relatively large, pressurized tank via a large diameter tube 271 and valve 272 opening and ensuring that the volume of the chamber 287 is large enough so that during the required acceleration duration, the chamber pressure is not significantly dropped.

The latter requirement is usually readily achieved since for most component acceleration shock testing, the required duration of the acceleration shock is usually a few milliseconds, thereby requiring a relatively short travel of the piston and piston rod assembly. This is in particular the case in munition component testing as well as testing various commercial components for possible damage during falls on various surfaces and other induced impact shock loading. For example, if a 1,000 G acceleration shock is to be applied to the object of testing for 5 milliseconds, then the piston and piston rod assembly would need to displace a distance d, where

$$d = \frac{1}{2} {at}^{2} \qquad ( 7 )$$

Where a is the applied acceleration shock level and t is the desired acceleration shock duration. For the above desired acceleration shock level of 1,000 G and duration of 5 milliseconds, the resulting piston and piston rod assembly displacement is calculated from equation (7)

$$d = \frac{1}{2} {at}^{2} = \frac{1}{2} ( 1000 ) ( 9.8 ) ( {0.005}^{2} ) = 0.1225 m ∼ 4.8 inch$$

That is, less than 5 inches, which can be readily achieved with the above 3-foot-long pneumatic cylinder.

It is therefore appreciated that by varying the air (gas) pressure in the compartment 287 of the pneumatic cylinder and the rate of air (gas) discharger form the compartment 288, the acceleration shock level of the test platform 285 and thereby the component(s) to be tested 286 can be adjusted to the desired level.

It is appreciated that once test platform 285, FIG. 29, and the provided component(s) being tested have been subjected to the desired acceleration shock level for the required duration, then the test platform needs to be brought smoothly to a stop. This requires that the piston and piston rod assembly be smoothly brought to a stop, and if a flexible cable 284 is used to connect the piston rod to the test platform, then the test platform itself must also be provided with the means to bring smoothly to a stop.

In general, the piston 267 and piston rod 268 assembly can be smoothly decelerated to a stop by providing properly sized shock absorbers between the stop member 277 and the pneumatic cylinder 266 (not shown), FIG. 29. Shock absorbers for smoothly bringing high speed equipment structures, such as in machine tools and other similar equipment, are well known in the art and are preferably mounted on the structure 283 of the present acceleration shock testing machine embodiment 270, along the path of motion of the stop member 277. If the terminal velocity of the piston rod assembly (i.e., the product of the test acceleration shock level and its duration) is not very high, then a shock absorbing assembly, such as a serially positioned Belville washers and shock absorbing elastomers discs 290 that is provided between the stop member 277 and the pneumatic piston 266 would be enough to prevent high velocity impact of the stop member 277 with the pneumatic cylinder head. Well known and properly sized shock absorbers can also be used to bring the test platform 285 smoothly to a stop following the applied acceleration event.

In certain applications, a device is used that is operated by the pulling of a lanyard at certain speed and acceleration profile. In such lanyard operated devices, it is highly desirable to test the device under realistic conditions, i.e., to examine its performance as its operating lanyard is pulled at the prescribed acceleration and speed profile. The pneumatic acceleration shock testing machine embodiment 270 of FIG. 29 may be used to perform such lanyard pulling tests at prescribed acceleration and velocity profiles. Such a configuration of the pneumatic acceleration shock testing machine embodiment 270 is shown in the schematic of FIG. 29A and is hereinafter indicated as the embodiment 310 of the present invention.

As can be seen in the schematic of FIG. 29A, all components of the pneumatic cylinder 266 and its associated air (gas) intake and outlet, the piston rod 268 stop member 277 and its release slide 280 and its components are identical to those of the embodiment of FIG. 29. The lanyard operated device 312 is then fixedly attached to the pneumatic machine structure 283. The device lanyard 311 is then attached to the tip 278 of the piston rod as shown in FIG. 29A.

To perform a lanyard pull test, the device 312 to be tested is fixedly attached to the base structure 283 of the lanyard pull machine, FIG. 29A. The device lanyard 311 is then fixedly attached to the tip 278 of the piston rod 268. The valve 275 is opened. The valve 272 is then opened to allow pressurized gas to flow into the pneumatic cylinder compartment 287 through the pipe 271 as shown by the arrow 273. It is appreciated that the pressurized compartment 287 and the ambient pressure in the aft compartment 288 of the pneumatic cylinder generates a differential pressure that would tend to accelerate the piston 267 to the right in the direction of the arrow 289. However, in the configuration of FIG. 29A, the tip 279 of the sliding member 280, which is in engagement with the stop member 277 of the piston rod 268 prevents rightward motion of the piston 267 and piston rod 268 assembly.

Then to begin to pull the lanyard at a prescribed acceleration to a prescribed speed, the sliding member 280 is pulled back from its tip 279 engagement with the stop member 277, thereby suddenly releasing the piston rod 268. The differential pressure between the chambers 287 and 288 would then apply a force over the area of the piston 267, which would accelerate the piston rod 268 and thereby the lanyard 311 in the direction of the arrow 289, FIG. 29A.

It is appreciated that as the piston 267 is accelerated and travels to the right in the in the direction of the arrow 289, FIG. 29A, the air (gas) contained in compartment 288 of the pneumatic cylinder 266 is exhausted through the outlet pipe 274 and through the open valve 275. The opening of the valve 275 is adjusted such that once the piston rod 268 and thereby the lanyard 311 velocity is at or close to the prescribed velocity, the level of velocity is maintained. It is appreciated that the adjusted valve 275 opening would function as an orifice and thereby limit the rate of air (gas) exhaust, thereby stabilizing the velocity of the piston rod and thereby the lanyard pulling velocity.

It is appreciated that in general, to minimize the initial transmitted jerk to the lanyard by the released piston rod 268, a relatively stiff elastic and damping element, such as a properly stacked Belville washers, may be provided in series with the lanyard at its connection 278 to the piston rod.

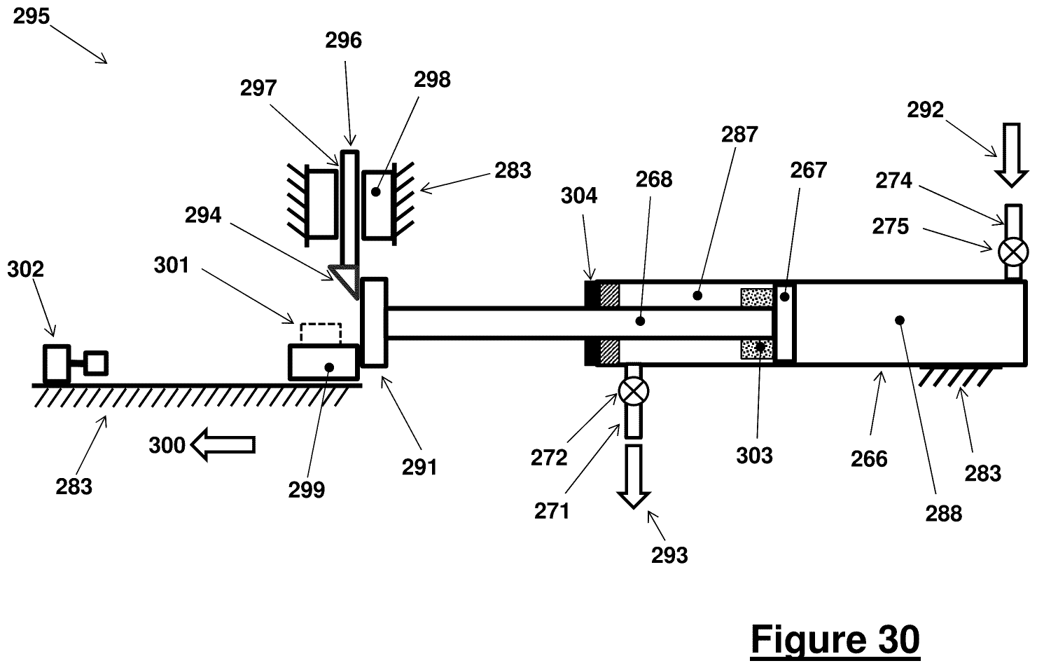

In the pneumatic acceleration shock testing machine embodiment 270 of FIG. 29, a cable 284 is used to transmit the accelerating motion of the piston 267 and piston rod 268 assembly to the test platform 285. The pneumatic acceleration shock testing machine may also be configured as shown in FIG. 30 to allow the piston 268 directly translate the test platform without the use of an intermediate cable or the like, and allowing the test platform to disengage from the piston and freely travel away at it attained speed once the application of the pistol accelerating force has ceased. This feature of this modified version of the pneumatic acceleration shock testing machine embodiment 270 of FIG. 29 has the advantage of allowing the test platform to be slowly decelerated to a stop following the application of the desired acceleration shock profile.

FIG. 30 illustrates the schematic of the modified pneumatic acceleration shock testing machine embodiment 270, which is hereinafter identified as the embodiment 295 of the present invention. In the modified pneumatic acceleration shock testing machine embodiment 295, the pneumatic cylinder 266 and all its components are identical to those of the pneumatic acceleration shock testing machine embodiment 270 of FIG. 29, and are indicated with the numeral, except for the stop member 291 (277 in FIG. 29), which is similarly fixedly attached to the piston rod 268. The pneumatic cylinder 266 of the modified pneumatic acceleration shock testing machine embodiment 295 would also operate differently as is described later.

In the modified pneumatic acceleration shock testing machine embodiment 295 of FIG. 30, the pneumatic cylinder 266 is also fixedly attached to the base structure 283 of the pneumatic acceleration shock testing machine. The connecting air (gas) pipe 274 with its open/close valve 275 is, however, used to allow pressurized air (gas) to enter the compartment 288 of the pneumatic cylinder 266, as indicated by the arrow 292. The connecting pipe 271 with its open/close valve is then used to allow the air (gas) to be exhausted from the compartment 287 of the pneumatic cylinder as indicated by the arrow 293.

As can be seen in the schematic of FIG. 30, the stop member 277 is fixedly attached to the free end of the piston rod 268. In the configuration of the pneumatic acceleration shock testing machine embodiment 295, the tip 294 of a sliding member 296 is in engagement with the stop member 291, preventing the piston rod 268 from displacing to the left as viewed in FIG. 30. The sliding member 296 is free to slide in the guide 297, which is provided in the member 298, which is fixedly attached to the base structure 283 of the pneumatic acceleration shock testing machine. In the configuration of the acceleration shock testing machine embodiment 295 shown in the schematic of FIG. 30, the test platform 299 is positioned against the stop member 291, and is usually held in full contact with the stop member, preferably with a light elastic member or adhesive tape or a light magnet or the like, to ensure that as the piston rod 268 begins to accelerate in the direction of the arrow 300 as described below, the stop member 291 and the test platform 299 would begin to accelerate together without experiencing any impact event. The test platform 299 is also preferably provided with attachment points such tapped holes and guides for fixedly attaching the object(s) to be tested 301 under acceleration shock loading. The test platform 299 is also preferably provided with a guide, such as those shown in FIG. 17A for the test platform 156, to ensure a controlled motion during acceleration shock testing.

To perform an acceleration shock testing, the component(s) to be tested 301 (shown with dashed lines) are fixedly attached to test platform 299, FIG. 30. The valve 272 is opened. The valve 275 is then opened to allow pressurized air (gas) to flow into the pneumatic cylinder compartment 288 through the pipe 274 as shown by the arrow 292. It is appreciated that the pressurized compartment 288 and the ambient pressure in the compartment 287 of the pneumatic cylinder generates a differential pressure that would tend to accelerate the piston 267 to the left in the direction of the arrow 300. However, in the configuration of FIG. 30, the tip 294 of the sliding member 296, which is in engagement with the stop member 291 of the piston rod 268 prevents leftward motion of the piston 267 and piston rod 268 assembly.

Then to subject the component(s) 301 to an acceleration shock test, the sliding member 296 is pulled back from its tip 294 engagement with the stop member 291, thereby suddenly releasing the piston rod 268. The differential pressure between the chambers 288 and 287 would then apply a force over the area of the piston 267, which would accelerate the piston rod 268 and thereby the test platform 299 and the components 301 that are being tested in the direction of the arrow 300, FIG. 30.

It is appreciated that as the piston 267 is accelerated and travels to the left in the in the direction of the arrow 300, FIG. 30, the air (gas) contained in compartment 287 of the pneumatic cylinder 266 is exhausted through the outlet pipe 271 and through the open valve 272. The opening of the valve 272 may therefore be used to control the rate of air discharge from the compartment 287 of the pneumatic cylinder 266, thereby adjust the acceleration and maximum velocity of the piston 267 and thereby the test platform 299.

It is also appreciated that to maximize the acceleration level of the piston 267 and thereby to connecting test platform 299, FIG. 30, the exhaust vale 272 and the exhaust pipe 271 must have relatively large openings to minimize their resistance to the outflow of the air (gas) contained in the compartment 287 of the pneumatic cylinder 266.

It is also appreciated that acceleration level of the piston 267 and thereby to connecting test platform 299, FIG. 30, can be further increased by using a vacuum pump to vacuum the compartment 287 of the pneumatic cylinder 266 before starting the acceleration shock testing, i.e., before disengaging the tip 294 of the sliding member 296 from the stop member 291. In general, the exhaust pipe 271 is preferably attached to a vacuum pump via a vacuum tank, so that the usually remained air (gas) in the compartment 287 would not cause an increase in the compartment pressure as the piston 267 moves close to the end of the pneumatic cylinder.

It is appreciated by those skilled in the art that if the differential air (gas) pressure between the compartments 287 and 288 of the pneumatic cylinder 266 is ΔP, and the area of the piston 267 of the pneumatic cylinder is A, then the net force F acting on the piston 267 and piston rod 268 assembly (neglecting the relatively small friction forces between the piston seals and internal surface of the piston cylinder and the seals 269, FIG. 29, and the piston rod) would also be given by equation (5). And if the total mass of the piston 267, piston rod 268, stop member 291, test platform 299, and the component(s) being tested 301 is m, then the test platform 299 and thereby the component(s) being tested 301 are going to be subjected to an acceleration a, given by equation (6).

It is appreciated that in many applications, the configuration of the modified acceleration shock testing machine embodiment 295 has several advantages over the acceleration shock testing machine embodiment 270 of FIG. 29, including the following.

Firstly, the surface area of the piston 267 exposed to the high-pressure air (gas) of the pneumatic cylinder compartment 288 is larger for the embodiment of FIG. 30 than the embodiment of FIG. 29 due to the absence of the piston rod 268.

Secondly, the total accelerating mass during a test is lower due to the absence of the attachment member 284 and its required cylinder rod 268 and tip member 278 and test platform 285, FIG. 29, connecting hardware.

Thirdly, since the test platform 299, FIG. 30, is not connected to the cylinder rod 268 by a connecting member (284 in the embodiment 270 of FIG. 29), once the piston rod acceleration has ceased, the test platform is free to continue its motion until is brought to a stop, usually smoothly.

It is appreciated that as the piston 267 and piston rod 268 is being accelerated in the direction of the arrow 300 following the release of the stop member 291, the pressure in the compartment 288 is desired to be maintained or drop a relatively small amount so that the acceleration of the piston and piston rod assembly and thereby the test platform 299 could be maintained. This is usually achieved by connecting the chamber 288 to a relatively large, pressurized tank via a large diameter tube 274 and valve 275 opening and ensuring that the volume of the chamber 288 is large enough so that during the required acceleration duration, the chamber pressure is not significantly dropped.

The latter requirement is usually readily achieved since for most component acceleration shock testing, the required duration of the acceleration shock is usually a few milliseconds, thereby requiring a relatively short travel of the piston and piston rod assembly. This is in particular the case in munition component testing as well as testing various commercial components for possible damage during falls on various surfaces and other induced impact shock loading. For example, if a 1,000 G acceleration shock is to be applied to the object of testing for 5 milliseconds, then the piston and piston rod assembly was shown to require only a distance of around 4.8 inch to travel, which for the indicated 3-foot pneumatic cylinder, can be readily achieved.

It is therefore appreciated that by varying the air (gas) pressure in the compartment 288 of the pneumatic cylinder and the rate of air (gas) discharger form the compartment 287, the acceleration shock level of the test platform 299 and thereby the component(s) to be tested 301, FIG. 30, can be adjusted to the desired level.

It is appreciated that once test platform 299, FIG. 30, and the provided component(s) being tested 301 have been subjected to the desired acceleration shock level for the required duration, then the test platform needs to be brought smoothly to a stop. This could, for example, be accomplished by providing a properly sixed shock absorber 302 or other shock absorbing materials along the path of test platform 299 to bring it smoothly to a stop. In general, a hard stop is not usually desired since it would impart a short duration and relatively high amplitude shock loading to the test platform and the component(s) being tested.

In addition, the piston 267 and piston rod 268 assembly must also be smoothly brought to a stop. In general, the piston 267 and piston rod 268 assembly can be smoothly decelerated to a stop by providing properly sized shock absorbers between the stop member 291 and the pneumatic cylinder 266 (not shown), FIG. 30. Shock absorbers for smoothly bringing high speed equipment structures, such as in machine tools and other similar equipment, are well known in the art and are preferably mounted on the structure 283 of the modified acceleration shock testing machine embodiment 295, along the path of motion of the stop member 291. If the terminal velocity of the piston rod assembly (i.e., the product of the test acceleration shock level and its duration) is not very high, then a shock absorbing assembly, such as a serially positioned Belville washers and shock absorbing elastomers discs 303, FIG. 30, may be provided between the piston 267 and the head member 304 of the pneumatic piston 266 to prevent their high velocity impact.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A shock testing machine comprising:
a test platform for holding an item to be shock tested and being movable in a testing direction, the testing direction being a direction of movement of the test platform;
a brake engaging member separately provided from the test platform and movable relative to the test platform, the brake engaging member contacting the test platform when the test platform is moving other than in a braking phase;
one or more rails movably supporting the test platform and the brake engaging member;
a stop configured to stop the brake engaging member from moving in the testing direction at a predetermined location while allowing the test platform to continue moving in the testing direction past the predetermined location; and
a brake configured to decelerate the test platform after the brake engaging member has been stopped by the stop, the brake being movable relative to the test platform and relative to the brake engaging member, the brake engaging member being provided between the test platform and the brake and the brake contacting the brake engagement member when the test platform is moving in the braking phase.

2. The shock testing machine according to claim 1, wherein the stop comprises first and second members positioned at the predetermined location at each of two side of the one or more rails to interfere with first and second portions, respectively, of the brake engaging member to begin the braking phase such that the test platform continues to move past the stop in the braking phase relative to each of the brake and the brake engaging member.

3. The shock testing machine according to claim 1, wherein one of the stop or the brake engaging member comprises a material on at least a portion of a contact surface between the stop and the brake engaging member for absorbing an impact between the stop and the brake engaging member.

4. The shock testing machine according to claim 1, wherein the one or more rails comprises first and second rails.

5. The shock testing machine according to claim 1, further comprising bearings provided between the one or more rails and one or more of the test platform and the brake engaging member.

6. The shock testing machine according to claim 1, wherein the brake comprises one or more elongated members extending from the test platform in a braking direction opposite to the testing direction, the one or more elongated members being engageable with braking material disposed on a braking body such that when the carriage enters the braking phase at the predetermined location and the test platform continues moving in the testing direction past the predetermined location, the brake engaging member engages the elongated member engages with the braking material to decelerate the testing platform.

7. The shock testing machine according to claim 6, wherein a braking force of the braking material against the one or more elongated members is adjustable to adjust a rate of the deceleration.

8. The shock testing machine according to claim 1, further comprising means for accelerating the carriage towards the stop.

9. A shock testing method comprising:
holding an item to be shock tested on a test platform;
accelerating the test platform towards a stop in a testing direction;
decelerating the test platform by applying a friction force from a braking member in which the braking member remains stationary behind the stop in the testing direction.

10. The shock testing method according to claim 9, further comprising adjusting a rate of the deceleration.

11. A shock testing machine comprising:
a test platform for holding an item to be shock tested and being movable in a testing direction, the testing direction being a direction of movement of the test platform;
one or more rails movably supporting the test platform and the brake engaging member;
a stop configured to decelerate the test platform at a predetermined location;
a brake configured to decelerate the test platform after the test platform has been decelerated by the stop; and
one or more bungee cords detachably connected to the test platform for applying an acceleration to the test platform in the testing direction, wherein the test platform and the stop are configured to disengage the one or more bungee cords from the test platform when the test platform moves past the stop in the testing direction.

12. The shock testing machine according to claim 11, wherein the one or more bungee cords comprises first and second bungee cords.

13. The shock testing machine according to claim 12, wherein the test platform has first and second bungee cord holders for holding the first and second bungee cords, respectively.

14. The shock testing machine according to claim 13, wherein the first and second bungee cord holders each having a first engagement portion facing the testing direction for engaging a corresponding portion of the stop and a first bungee cord holding portion facing a direction opposite to the testing direction for accommodating a corresponding first portion of a corresponding one of the first and second bungee cords.

15. The shock testing machine according to claim 14, wherein the corresponding portion of the stop comprises first and second stop portions corresponding to the first engagement portion of each of the first and second bungee cord holders, the first and second stop portions engaging the first engagement portion of each of the first and second bungee cord holders when the test platform moves past the stop in the testing direction such that the first and second bungee cords disengage from the first and second bungee cord holders and engage with the first and second stop portions.

16. The shock testing machine according to claim 15, wherein the first and second stop portions each have a second engagement portion for engaging with a respective first engagement portion of the first and second bungee cord holders and a second bungee cord holding portion for accommodating a corresponding second portion of a corresponding one of the first and second bungee cords.

18. A shock testing method comprising:
holding an item to be shock tested on a test platform;
accelerating the test platform towards a stop in a testing direction with one or more bungee cords engaged with the test platform;
decelerating the test platform by applying a friction force from a braking member in which the braking member remains stationary behind the stop in the testing direction; and
disengaging the one or more bungee cords from the test platform when the test platform moves past the stop in the testing direction.

19. The shock testing method of claim 18, further comprising, subsequent to the disengaging, engaging the one or more bungee cords with the stop.
